(19) United States
(12) Patent Application Publication
(10) Pub. No.: US 2025/0282444 A1
(43) Pub. Date: Sep. 11, 2025

(54) DRIVE UNIT AND ELECTRIC VEHICLE

(71) Applicant: Panasonic Intellectual Property Management Co., Ltd., Osaka (JP)

(72) Inventor: Masafumi KAWAKAMI, Osaka (JP)

(73) Assignee: Panasonic Intellectual Property Management Co., Ltd., Osaka (JP)

(21) Appl. No.: 18/976,617

(22) Filed: Dec. 11, 2024

(30) Foreign Application Priority Data
Mar. 8, 2024 (JP) 2024-035841

(51) Int. Cl. B62M 6/55; B62M 6/45; B62M 9/06; B62M 11/14

(52) U.S. Cl. CPC B62M 6/55; B62M 6/45; B62M 9/06; B62M 11/145

(57) ABSTRACT

A drive unit used for an electric vehicle includes: a motor; a crankshaft; a sprocket that outputs a rotational power of the motor; and a power transmission mechanism that decelerates or accelerates the rotational power of the motor to transmit the power to the sprocket, wherein the power transmission mechanism includes at least one gear provided with tooth portions on a surface, the rotor and the tooth portions are disposed at positions overlapping in an axial direction of the crankshaft, and at least part of the gear is disposed inside the opening portion.

### CROSS REFERENCE TO RELATED APPLICATION

The entire disclosure of Japanese Patent Application No. 2024-035841 filed on Mar. 8, 2024 including the specification, claims, drawings, and abstract is incorporated herein by reference in its entirety.

### TECHNICAL FIELD

The present disclosure relates to a drive unit, and an electric vehicle that includes the drive unit.

### BACKGROUND

Conventionally, as a drive unit for use in an electric vehicle, there has been a known drive unit that includes a motor, and a power transmission mechanism for transmitting a rotational power of the motor to a sprocket (for example, see JP 7246001 B).

### SUMMARY

### Technical Problem

In recent years, there has been demand for reduction in the size of drive units. In JP 7246001 B, a motor included in the drive unit and a board connected to the motor are placed close together to reduce the size of a drive unit. Meanwhile, the prior arts, including JP 7246001 B, leave room for improvement in reducing the size of the drive unit.

### Solution to Problem

A drive unit of an aspect of the present disclosure is a drive unit for use in an electric vehicle, including: a motor that includes a rotor having an opening portion at a rotation center; a housing that houses the motor; a crankshaft rotatably attached to the housing; a sprocket that outputs a rotational power of the motor; and a power transmission mechanism that decelerates or accelerates the rotational power of the motor to transmit to the sprocket, wherein the power transmission mechanism includes at least one gear provided with tooth portions on a surface, the rotor and the tooth portions are disposed at positions overlapping in an axial direction of the crankshaft, and at least part of the gear is disposed inside the opening portion.

A drive unit of an aspect of the present disclosure is a drive unit for use in an electric vehicle, including: a motor that includes a rotor having an opening portion at a rotation center; a housing that houses the motor; a crankshaft that is rotatably attached to the housing, and is rotatable by a human-power driving force; a first sprocket that outputs a rotational power of the motor; a second sprocket that outputs a rotational power of the human-power driving force; and a power transmission mechanism that decelerates or accelerates the rotational power of the motor to transmit to the first sprocket, wherein the power transmission mechanism includes at least one gear provided with tooth portions on a surface, the rotor and the tooth portions are disposed at positions overlapping in an axial direction of the crankshaft, and at least part of the gear is disposed inside the opening portion.

A drive unit of an aspect of the present disclosure is a drive unit for use in an electric vehicle, including: a motor that includes a rotor having an opening portion at a rotation center; a housing; a crankshaft rotatably attached to the housing; a sprocket that outputs a rotational power of the motor; and a power transmission mechanism that decelerates or accelerates the rotational power of the motor to transmit to the sprocket, wherein the power transmission mechanism includes at least one gear provided with tooth portions on a surface, the rotor and the tooth portions are disposed at positions overlapping in an axial direction of the crankshaft, and a rotation axis of the rotor and a rotation axis of the crankshaft are concentrically disposed.

A drive unit of an aspect of the present disclosure is a drive unit for use in an electric vehicle, including: a motor; a housing that houses the motor; a crankshaft rotatably attached to the housing; a sprocket that outputs a rotational power of the motor; and a power transmission mechanism that decelerates or accelerates the rotational power of the motor to transmit to the sprocket; and a rotation detecting portion that detects rotation of the crankshaft or of a member rotating integrally with the crankshaft, wherein the rotation detecting portion rotates integrally with the crankshaft.

A drive unit of an aspect of the present disclosure is a drive unit for use in an electric vehicle, including: a motor; a housing that houses the motor; a crankshaft rotatably attached to the housing; a sprocket that outputs a rotational power of the motor; and a power transmission mechanism that decelerates or accelerates the rotational power of the motor to transmit to the sprocket, wherein the motor includes: a motor shaft that is an output shaft; a stator fixed to the housing; and a rotor that is fixed to the motor shaft and includes a magnet, the rotor is disposed so as to face the stator in a direction along a rotation axis of the motor shaft, the power transmission mechanism includes at least one gear provided with tooth portions on a surface, and the stator and the tooth portions are disposed at positions overlapping in an axial direction of the crankshaft.

### Advantageous Effects of Invention

The drive unit according to the present disclosure can be of reduced size. Despite its small size, the drive unit according to the present disclosure can produce sufficient output characteristics for a drive source of an electric vehicle.

### BRIEF DESCRIPTION OF DRAWINGS

Embodiments of the present disclosure will be described based on the following figures, wherein:

FIG. 1 shows an appearance of a power-assisted bicycle according to a first embodiment;

FIG. 2 is a sectional view of a drive unit according to the first embodiment;

FIG. 3 is a sectional view of the drive unit according to the first embodiment, and shows an enlarged view of the vicinity of a motor;

FIG. 4 is a sectional view of a one-way clutch included in the drive unit according to the first embodiment;

FIG. 5 is a sectional view of a drive unit according to a second embodiment;

FIG. 6 is a sectional view of the drive unit according to the second embodiment, and shows an enlarged view of the vicinity of a motor;

FIG. 7 is a sectional view of a drive unit according to a third embodiment;

FIG. 8 is a sectional view of the drive unit according to the third embodiment, and shows an enlarged view of the vicinity of a motor;

FIG. 9 is a sectional view of a drive unit according to a fourth embodiment;

FIG. 10 is a sectional view of the drive unit according to the fourth embodiment, and shows an enlarged view of the vicinity of a motor;

FIG. 11 is a sectional view of a drive unit according to a fifth embodiment;

FIG. 12 is a sectional view of the drive unit according to the fifth embodiment, and shows an enlarged view of the vicinity of a motor;

FIG. 13 is a sectional view of a drive unit according to a sixth embodiment;

FIG. 14 is a sectional view of a drive unit according to a seventh embodiment;

FIG. 15 is a sectional view of the drive unit according to the seventh embodiment, and shows an enlarged view of the vicinity of a motor;

FIG. 16 is a sectional view of a drive unit according to an eighth embodiment;

FIG. 17 is a sectional view of the drive unit according to the eighth embodiment, and shows an enlarged view of the vicinity of a motor;

FIG. 18 is a sectional view of a drive unit according to a ninth embodiment;

FIG. 19 is a sectional view of a drive unit according to a tenth embodiment;

FIG. 20 is a sectional view of a drive unit according to an eleventh embodiment;

FIG. 21 is a sectional view of the drive unit according to the eleventh embodiment, and shows an enlarged view of the vicinity of a motor;

FIG. 22 is a sectional view of a drive unit according to a twelfth embodiment; and

FIG. 23 is a sectional view of the drive unit according to the twelfth embodiment, and shows an enlarged view of the vicinity of a motor.

### DESCRIPTION OF EMBODIMENTS

Hereinafter, a drive unit, and an electric vehicle that includes the drive unit according to the present disclosure are described in detail. Each of embodiments described below is only an example, and the present disclosure is not limited to the following embodiments. Any forms made up by selectively combining the embodiments and modification examples described below are encompassed in the present disclosure.

### First Embodiment

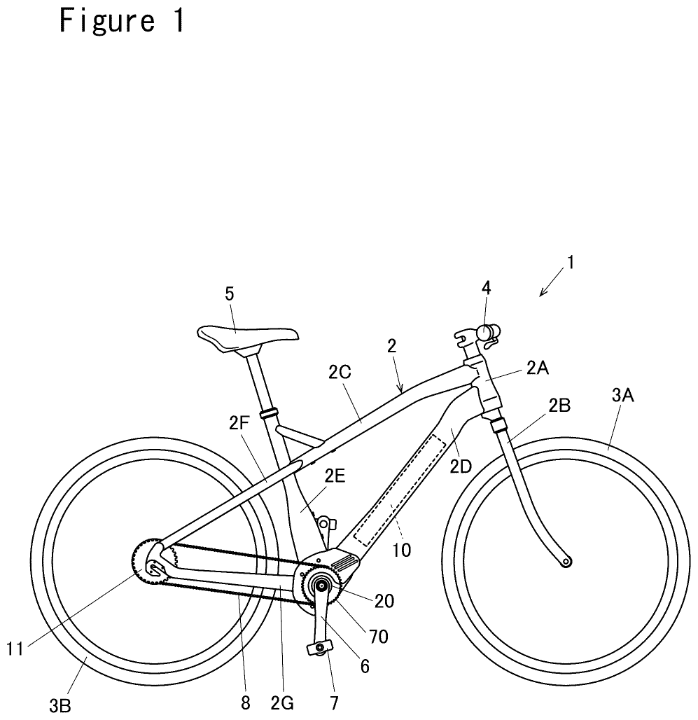

Hereinafter, by reference to FIGS. 1 to 4, a first embodiment of a drive unit and an electric vehicle in the present disclosure is described.

FIG. 1 is a right side view showing an appearance of a power-assisted bicycle 1 that is an electric vehicle according to the first embodiment. Note that the electric vehicle in the present disclosure is not limited to the power-assisted bicycle 1, and may be an electric vehicle that travels by the power of a motor. The power-assisted bicycle 1 in the present disclosure is not limited to a sport bicycle as shown in FIG. 1, and may be, for example, a city bike, a folding bicycle or the like. Hereinafter, the front-rear, left-right, and up-down directions in the embodiments in the present disclosure mean the front-rear, left-right, and up-down directions with reference to a state in which a rider is seated on a saddle 5 of the power-assisted bicycle 1 facing handlebars 4.

As shown in FIG. 1, similar to a typical bicycle, the power-assisted bicycle 1 includes a frame 2, a front wheel 3A, a rear wheel 3B, the handlebars 4, and the saddle 5.

The frame 2 is a framework that connects the front wheel 3A, the rear wheel 3B, the handlebars 4, the saddle 5, and the like. The frame 2 includes a plurality of tubes. A head tube 2A, front forks 2B, a top tube 2C, a bottom tube 2D, a seat tube 2E, seat stays 2F, and chain stays 2G are provided as the plurality of tubes.

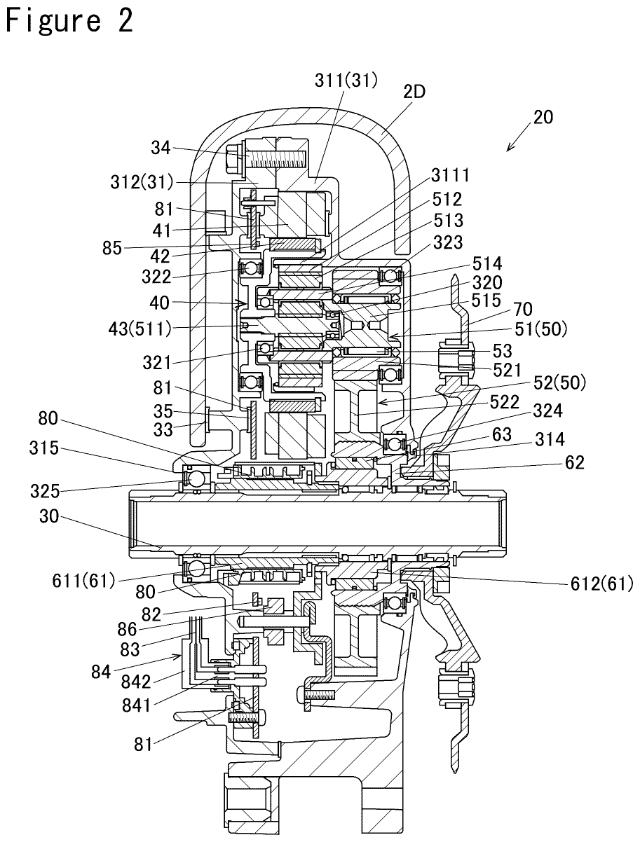

The power-assisted bicycle 1 further includes a drive unit 20, and a power storage device 10 that supplies the drive unit 20 with electric power. The power-assisted bicycle 1 has a function of assisting the driving force resulting from the pedaling force of a rider (human-power driving force) with the power of a motor 40 (see FIG. 2 described later) of the drive unit 20.

As described in detail later, part of the drive unit 20 is housed in the bottom tube 2D. Note that the drive unit 20 may be attached to the outside of the frame 2, instead of being housed in the bottom tube 2D.

The drive unit 20 includes a pair of crank arms 6 to which pedals 7 are respectively attached. The crank arms 6 are provided to the left and right of the power-assisted bicycle 1, one for each side. The other end portions of the pair of crank arms 6 are both coupled to a crankshaft 30 (see FIG. 2).

The drive unit 20 includes a sprocket 70. The power-assisted bicycle 1 includes a chain 8 as a mechanism that transmits the rotational power of the sprocket 70 to the rear wheel 3B. The chain 8 couples the sprocket 70 to a rear wheel sprocket 11 provided to the rear wheel 3B. Note that the sprocket 70 and the rear wheel sprocket 11 may be coupled by a belt or shaft drive.

The power storage device 10 is a power source device that supplies the drive unit 20 with electric power. In an example shown in FIG. 1, the power storage device 10 is attached outside the bottom tube 2D. Note that the position of the power storage device 10 is not limited to the bottom tube 2D, and this device may be attached to the top tube 2C or the seat tube 2E. Alternatively, the power storage device 10 may be housed in the frame 2.

Preferably, a secondary battery is used as a battery housed in the power storage device 10. Alternatively, a primary battery may be used. The voltage of the power storage device 10 may range, for example, from 12 V to 48 V, inclusive. The power storage device 10 may be provided with a voltage conversion circuit. The voltage conversion circuit may be provided in the power storage device 10, or provided outside the power storage device 10.

Next, by reference to FIG. 2, the drive unit 20 according to the first embodiment is described. FIG. 2 is a sectional view of the drive unit 20.

As shown in FIG. 2, the drive unit 20 includes: the motor 40 for applying rotational power for assisting the pedaling force on the pedals 7 (see FIG. 1); a housing 31 that houses the motor 40; and the crankshaft 30 rotatably attached to the housing 31. The drive unit 20 is a so-called center unit type drive unit.

The drive unit 20 further includes: a human power transmission body 61 that is attached so as to rotate integrally with the crankshaft 30, and is rotated by a human-power driving force; an output body 62 that outputs the rotational power of the motor 40; the sprocket 70 that outputs the rotational power of the output body 62; and a power transmission mechanism 50 that decelerates the rotational power of the motor 40, and transmits it to the sprocket 70 via the output body 62.

As described in detail later, the output body 62 functions as a power combination body at which the rotational power of the human-power driving force and the rotational power of the motor 40 are combined. In the present embodiment, the power transmission mechanism 50 is made up of two stages of speed reduction mechanisms, and includes: a planetary gear mechanism (first power transmission mechanism) 51 that is a first-stage speed reduction mechanism; and a second speed reduction mechanism (second power transmission mechanism) 52 that is a second-stage speed reduction mechanism.

As shown in FIG. 2, the motor 40 includes a stator 41, a rotor 42, and a motor shaft 43 that rotates integrally with the rotor 42. In the present embodiment, the motor 40 is an inner-rotor type motor. As described above, the motor 40 is housed in the housing 31.

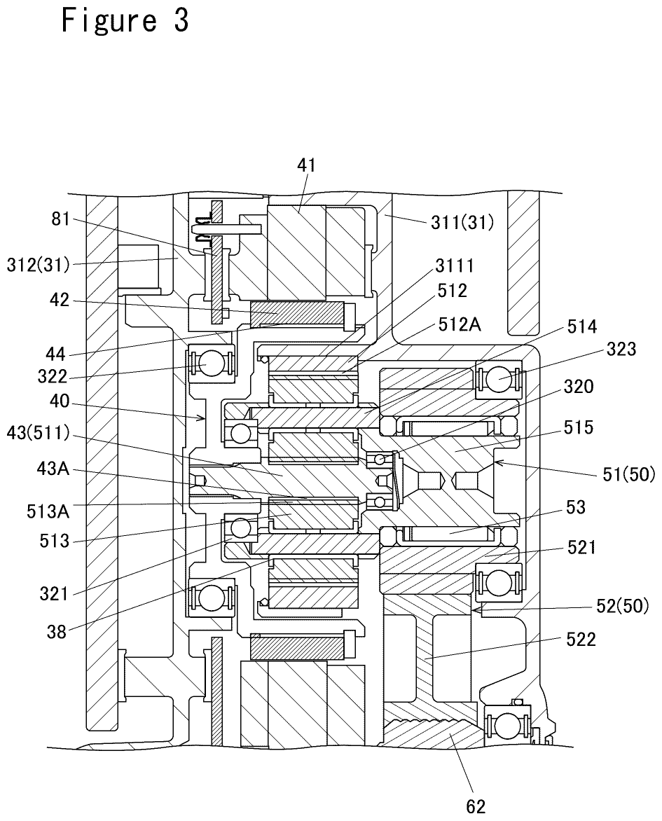

The stator 41 is fixed to the inside of the housing 31 by press-fitting or with adhesive or a pin. The rotor 42 has an annular shape that has a circular opening portion 44 (see FIG. 3) at the rotation center, and is disposed inside the stator 41. As described in detail later, a sun gear 511, an internal gear 512, planetary gears 513, and a planetary gear shaft 514 that are gears constituting the planetary gear mechanism 51 are disposed inside the opening portion 44 in the radial direction.

The motor shaft 43 is the output shaft of the motor 40, and is disposed such that the rotation axis is along the axial direction of the crankshaft 30. The motor shaft 43 is rotatably supported by bearings 320, 321, and 322 provided in the housing 31, so as to be rotatable with respect to the housing 31. The rotor 42 and the motor shaft 43 are fixed to each other by serrations, for example.

The housing 31 is a member that constitutes an outer shell of the drive unit 20. The housing 31 is formed mainly of metal, such as aluminum, stainless steel, or magnesium. Alternatively, a non-metal material may be used. No specific limitation is imposed on the material of the housing 31.

The housing 31 includes: a first divided body 311 that constitutes the right half of the housing 31; and a second divided body 312 that constitutes the left half of the housing 31. The first divided body 311 and the second divided body 312 are joined together with a fastener member 34, such as a bolt. By joining the first divided body 311 and the second divided body 312 to each other, the hollow housing 31 is formed. Note that no specific limitations are imposed on the size, shape, thickness, and the like of the housing 31. The space formed in the housing 31 may be closed, or not closed.

The first divided body 311 includes a protruding portion 3111 that protrudes to the left. The internal gear 512 included in the planetary gear mechanism 51 is fitted to the protruding portion 3111.

The human power transmission body 61, part of the output body 62, the planetary gear mechanism 51, and the second speed reduction mechanism 52, in addition to the motor 40, are housed in the housing 31. The housing 31 is provided with through-holes 314 and 315 through which the crankshaft 30 penetrates, at its opposite ends.

In the present embodiment, part of the housing 31 is housed in the bottom tube 2D. Between the housing 31 and the bottom tube 2D (frame 2) there is disposed a heat dissipation member 33 that transfers the heat of the housing 31 to the bottom tube 2D. That is, the heat of the housing 31 is transferred to the bottom tube 2D via the heat dissipation member 33. In general, the temperature of the housing 31 tends to be increased by the heat of the motor 40 and the like housed in the housing 31. As in the present embodiment, by disposing the heat dissipation member 33 between the housing 31 and the bottom tube 2D, the temperature of the housing 31 can be reduced, and the reliability of the drive unit 20 can be improved. Note that it may be configured so as to allow the heat of the housing 31 to be transferred to members other than the bottom tube 2D via the heat dissipation member 33.

For example, an elastic body that has a higher thermal conductivity than typical resin and is compressible can be used as the heat dissipation member 33. An example of a preferable heat dissipation member 33 is a heat release sheet that includes flexible resin, and thermal conductive filler dispersed in the resin. The thickness of the heat dissipation member 33 ranges, for example, from 0.3 mm to 2 mm, inclusive. Note that a conventionally publicly known member may be used as the heat dissipation member 33.

The heat dissipation member 33 may have adherence, and be adhesive to the surface or the like of the housing 31 or the bottom tube 2D. In the case where the heat dissipation member 33 is adhesive to the surface or the like of the housing 31 or the bottom tube 2D, the heat dissipation member 33 can be easily installed. Note that the heat dissipation member 33 may be pasted to the surface or the like of the housing 31 or the bottom tube 2D using adhesive, adhesive tape, or the like.

The crankshaft 30 is a cylindrical member rotationally driven by a human-power driving force. The crankshaft 30 rotates with respect to the drive unit 20. In the present embodiment, the crankshaft 30 is made up of a hollow member, but may be made up of a solid member instead.

The opposite ends of the crankshaft 30 protrude outward from the housing 31. A pair of crank arms 6 (see FIG. 1) are respectively provided at the opposite ends of the crankshaft 30. The crankshaft 30 is rotatably supported by bearings 324 and 325 at the housing 31 (frame 2). The bearings 324 and 325 are made up of, for example, ball bearings.

The power transmission mechanism 50 is a mechanism that decelerates the rotational power of the motor 40, and transmits the rotational power of the motor 40 to the sprocket 70 via the output body 62. In the present embodiment, the power transmission mechanism 50 is made up of the two stages of the speed reduction mechanisms, and includes: the planetary gear mechanism 51 that is the first-stage speed reduction mechanism; and the second speed reduction mechanism 52 that is the second-stage speed reduction mechanism. Note that the power transmission mechanism 50 may include an acceleration mechanism.

As described in detail later, the planetary gear mechanism 51 includes: the motor shaft 43 as the sun gear 511; the internal gear 512 disposed on a concentric circle of the sun gear 511; the planetary gears 513 that mesh with the sun gear 511 and the internal gear 512; the planetary gear shafts 514; and a planetary carrier 515 as an output shaft. The internal gear 512 is non-rotatably fixed to the housing 31 by being fitted to the protruding portion 3111 of the housing 31. The rotational power of the motor 40 output from the planetary carrier 515 is transmitted to the second speed reduction mechanism 52 via a one-way clutch 53.

When the rotational power in a direction (hereinafter, called “forward direction”) of accelerating the power-assisted bicycle 1 in the traveling direction is applied to the planetary carrier 515, the one-way clutch 53 transmits the rotational power to a first transmission gear 521 included in the second speed reduction mechanism 52. When the rotational power in the direction opposite to the forward direction is applied to the planetary carrier 515, the one-way clutch 53 does not transmit the rotational power to the first transmission gear 521. When the rotational power in the forward direction is applied to the first transmission gear 521, the one-way clutch 53 does not transmit the rotational power to the planetary carrier 515.

The second speed reduction mechanism 52 includes the first transmission gear 521, and a second transmission gear 522. The rotation axis of the first transmission gear 521 is positioned concentrically on the rotation axis of the sun gear 511. The rotation axis of the second transmission gear 522 is positioned concentrically on the rotation axis of the crankshaft 30. That is, the outer diameter of the second transmission gear 522 is larger than the outer diameter of the first transmission gear 521. The number of teeth of the second transmission gear 522 is greater than the number of teeth of the first transmission gear 521.

The first transmission gear 521 is disposed outside the planetary carrier 515 in the radial direction, and the rotational power of the motor 40 is transferred to this gear via the one-way clutch 53. The first transmission gear 521 is rotatably supported by a bearing 323 (first bearing) at the housing 31.

The second transmission gear 522 meshes with tooth portions provided on the outer peripheral surface of the output body 62. Accordingly, the rotational power of the motor 40 transmitted to the second transmission gear 522 is transmitted to the output body 62.

Here, the bearing 323 (first bearing) that rotatably supports the first transmission gear 521, and the one-way clutch 53 may be disposed at positions overlapping in the axial direction of the crankshaft 30. Accordingly, reduction in size of the drive unit 20 can be facilitated.

The second speed reduction mechanism 52, and a bearing 320 (second bearing) that is provided at the distal end (right end) of the motor shaft 43 as the sun gear 511 and rotatably supports the motor shaft 43 are disposed at positions overlapping in the axial direction of the crankshaft 30. Accordingly, reduction in size of the drive unit 20 can be facilitated.

Note that in the present embodiment, the second speed reduction mechanism 52 includes the two gears made up of the first transmission gear 521 and the second transmission gear 522. However, the number of gears may be one, or three or more. The power transmission mechanism 50 may be a single-stage speed reduction mechanism, or a speed reduction mechanism having three or more stages.

The human power transmission body 61 is a cylindrical member that extends along the axial direction of the crankshaft 30, and is disposed on the outer peripheral portion of the crankshaft 30 in the housing 31. The human power transmission body 61 rotates integrally with the crankshaft 30. In the present embodiment, the human power transmission body 61 is divided into a first human power transmission body 611 and a second human power transmission body 612. Note that the human power transmission body 61 may be made up of a single member.

The first human power transmission body 611 is coupled to the crankshaft 30. Splines or serrations to be fitted to the crankshaft 30 are formed in the inner peripheral surface of the first human power transmission body 611. Note that a tooth missing part may be provided at a site where the first human power transmission body 611 and the crankshaft 30 fit each other. This allows positioning in the assembling direction, and facilitates assembly. The first human power transmission body 611 and the crankshaft 30 may be fitted together by press-fitting or with a screw.

The second human power transmission body 612 is disposed on the right side of the first human power transmission body 611 in the axial direction of the crankshaft 30. The second human power transmission body 612 is coupled to the first human power transmission body 611, and transmits the rotational power to the output body 62.

In the present embodiment, splines or serrations to be fitted to the inner peripheral surface of the left end of the second human power transmission body 612 are formed in the outer peripheral surface of the right end of the first human power transmission body 611. Accordingly, the first human power transmission body 611 and the second human power transmission body 612 are coupled to each other.

No specific limitations are imposed on the lengths of the first human power transmission body 611 and the second human power transmission body 612 in the axial direction of the crankshaft 30, so long as the rotational power by the human-power driving force can be transmitted to the output body 62. For example, each of the lengths ranges from 5% to 40%, inclusive, of the length of the crankshaft 30 in the axial direction. In the present embodiment, the length of the first human power transmission body 611 in the axial direction of the crankshaft 30 is greater than the length of the second human power transmission body 612. Note that the length of the first human power transmission body 611 in the axial direction of the crankshaft 30 may be shorter than the length of the second human power transmission body 612.

The output body 62 is a cylindrical member that extends along the axial direction of the crankshaft 30, and is disposed on the outer peripheral portion of the crankshaft 30. The rotation axis of the output body 62 is concentrically positioned on the rotation axis of the crankshaft 30.

The length of the output body 62 in the axial direction of the crankshaft 30 is shorter than the length of the crankshaft 30, and ranges, for example, from 10% to 50%, inclusive, of the length of the crankshaft 30 in the axial direction. The right end of the output body 62 protrudes to the outside of the housing 31 through the through-hole 314 provided in the housing 31. The output body 62 is rotatably supported by the bearing 324 at the housing 31.

Tooth portions to be meshed with the tooth portions of the second transmission gear 522 are provided on the outer peripheral surface of the output body 62. Accordingly, the rotational power of the motor 40 is transmitted to the output body 62 via the second transmission gear 522.

In the present embodiment, a one-way clutch 63 is provided between the second human power transmission body 612 and the output body 62. When the rotational power in the forward direction is applied to the second human power transmission body 612, the one-way clutch 63 transmits the rotational power to the output body 62. When the rotational power in the direction opposite to the forward direction is applied to the second human power transmission body 612, the one-way clutch 63 does not transmit the rotational power to the output body 62. When the rotational power in the forward direction is applied to the output body 62 via the power transmission mechanism 50, the one-way clutch 63 does not transmit the rotational power to the second human power transmission body 612. The one-way clutch 63 also functions as a bearing, and rotatably supports the output body 62. Note that the configuration of the one-way clutch 63 is described later.

Splines or serrations to be fitted to the sprocket 70 are formed in a portion of the output body 62 that protrudes to the outside of the housing 31. Accordingly, the sprocket 70 rotates integrally with the output body 62. Note that an elastic member for regulating the movement of the sprocket 70 may be disposed between the output body 62 and the sprocket 70.

Note that the human power transmission body 61 and the output body 62 are provided separately in the present embodiment, but may be integrally configured instead. For example, the human power transmission body 61 is not necessarily provided, and it may be the case that only the output body 62 is provided. In this case, by transmitting the rotational power of the crankshaft 30 due to the human-power driving force to the output body 62, the power-assisted bicycle 1 is allowed to travel forward.

A one-way clutch may be disposed between the output body 62 and the sprocket 70. When the rotational power in the forward direction is applied to the output body 62, the one-way clutch transmits the rotational power to the sprocket 70. When the rotational power in the direction opposite to the forward direction is applied to the output body 62, the one-way clutch does not transmit the rotational power to the sprocket 70.

Here, the power transmission path in the drive unit 20 is described. First, the power transmission path of the human-power driving force applied to the pedals 7 is described. The rider pushes down the pedals 7 of the power-assisted bicycle 1, which rotates the crankshaft 30 in the forward direction. When the crankshaft 30 rotates in the forward direction, the human power transmission body 61 fitted to the outer peripheral portion of the crankshaft 30 rotates in the forward direction integrally with the crankshaft 30. The rotational power of the human power transmission body 61 rotating in the forward direction is transmitted to the output body 62 for outputting the rotational power of the motor 40. The output body 62, and the sprocket 70 fixed to the output body 62 integrally rotate in the forward direction. When the sprocket 70 rotates in the forward direction, the rotational power in the forward direction is applied to the rear wheel sprocket 11 via the chain 8, and the rear wheel sprocket 11 and the rear wheel 3B rotate in the forward direction. Accordingly, the power-assisted bicycle 1 travels forward.

Next, the power transmission path of the rotational power of the motor 40 is described. When the motor shaft 43 of the motor 40 rotates in the forward direction, the rotational power is transmitted to the output body 62 via the power transmission mechanism 50, which includes the planetary gear mechanism 51 and the second speed reduction mechanism 52. That is, the output body 62 functions as a power combination body at which there are combined the rotational power from the human power transmission body 61 by the human-power driving force described above, and the rotational power of the motor 40. The rotational power of the motor 40 transmitted to the output body 62 is transmitted to the rear wheel 3B on the power transmission path similar to that for the human-power driving force described above, and the power-assisted bicycle 1 travels forward.

The drive unit 20 includes torque detecting portions 80 that detect the torque of the human-power driving force; and a control board 81 on which there is disposed a control device (not shown) for controlling the output of the motor 40 in response to the detected torque and achieving an appropriate power assisting function. The drive unit 20 further includes a rotation detecting portion 82 for detecting the rotation of the crankshaft 30.

The torque detecting portions 80 are provided on the outer peripheral portion of the first human power transmission body 611, and detect the strain applied to the first human power transmission body 611. For example, a strain sensor that detects a physical strain, or a strain sensor that detects a magnetic strain may be used as each torque detecting portion 80. For example, a scheme may be used in which a paint that emits light in response to a mechanical stimulus is applied to the outer peripheral portion of the human power transmission body 61 and the light is detected by an optical sensor.

In the present embodiment, the drive unit 20 includes total two torque detecting portions 80, one at each of the opposite positions in the circumferential direction on the outer peripheral portion of the first human power transmission body 611. Note that the number of torque detecting portions 80 provided on the outer peripheral portion of the first human power transmission body 611 may be only one, or three or more. The installation positions of the torque detecting portions 80 are not limited to the outer peripheral portion of the first human power transmission body 611, and may be on, for example, the outer peripheral portion of the second human power transmission body 612 or the crankshaft 30.

The control device is disposed on the control board 81, and controls the rotation of the motor 40 based on the torque detected by each torque detecting portion 80. The control device controls the rotation of the motor 40 based on detection information on the rotation detecting portion 82. A conventionally publicly known configuration may be adopted as the configuration of the control device.

The torque detecting portion 80 and the rotation detecting portion 82 may communicate with the control device by means of signal lines or wireless signals. In the case of communication by means of the wireless signals, cables that connect the torque detecting portion 80 and the rotation detecting portion 82 to the control device are not required, which facilitates reduction in size of the drive unit 20.

In the present embodiment, the control board 81 is made up of a single board that has through-holes through which the crankshaft 30 and the motor 40 penetrate. The control board 81 is disposed such that the substantially normal direction of the surface (thickness direction) can be along the axial direction of the crankshaft 30. Note that the control board 81 may be made up of multiple boards.

Part of the control board 81 is joined to the motor 40. The part of the control board 81 is joined to the motor 40, and the control board 81 and the motor 40 are disposed close to each other, which can shorten the cable that connects the control board 81 to the motor 40, thus facilitating reduction in the size of the drive unit 20.

Part of the control board 81 is joined to the second divided body 312. In the present embodiment, the control board 81 and the second divided body 312 are joined to each other via a heat dissipation member 35. A configuration similar to that of the heat dissipation member 33 intervening between the housing 31 and the down tube 2D may be used for the heat dissipation member 35.

The control board 81 may be provided with, for example, a rotor rotation detecting portion 85 for detecting the rotation of the rotor 42. The rotor rotation detecting portion 85 includes, for example, a Hall element. The Hall element detects the variation in the magnetic field caused by the rotation of the rotor 42, thus allowing measurement of the number of rotations of the rotor 42. Note that the magnetic force detected by the Hall element may be the magnetic force of a member that rotates together with the rotor 42.

A cable 83 extending from the outside of the drive unit 20 is connected via a connector 84 to the control board 81. Note that the connector 84 is an element separated from the drive unit 20. The cable 83 is connected to, for example, the power storage device 10 (see FIG. 1), and supplies electric power to electronic devices disposed on the control board 81.

The connector 84 includes a first portion 841 that extends in a substantially normal direction of a surface of the control board 81, and a second portion 842 that extends in a direction inclined from the substantially normal direction of the surface of the control board 81. In the present embodiment, the second portion 842 is configured so as to be substantially perpendicular to the first portion 841. That is, the connector 84 is bent substantially perpendicularly. Accordingly, the length of the connector 84 in the left-right direction can be reduced, which can reduce the size of the drive unit 20.

The rotation detecting portion 82 detects the number of rotations of the crankshaft 30. The rotation detecting portion 82 internally includes, for example, a Hall element, and is disposed at a position overlapping the magnet 86 provided on the outer peripheral portion of the first human power transmission body 611. The Hall element detects the variation in the magnetic field of the magnet by the rotation of the crankshaft 30, thus allowing measurement of the number of rotations of the crankshaft 30. Note that the configuration of the rotation detecting portion 82 is not limited to this. The rotation detecting portion 82 may be, for example, an inertial sensor, such as an acceleration sensor or a gyroscope sensor.

In the present embodiment, the rotation detecting portion 82 is disposed on the control board 81. By disposing the rotation detecting portion 82 on the control board 81, the rotation detecting portion 82 can be disposed without increasing the number of boards. Accordingly, reduction in size of the drive unit 20 can be facilitated.

Next, by further reference to FIG. 3, the motor 40, and the gears constituting the planetary gear mechanism 51 are described in detail. FIG. 3 is an enlarged view of the vicinity of the motor 40 in FIG. 2.

As shown in FIG. 3, the motor 40 includes the stator 41, the rotor 42, and the motor shaft 43 that rotates integrally with the rotor 42.

The stator 41 is fixed to the inside of the housing 31 by press-fitting, with adhesive, by screwing, or with a pin. In this case, an elastic member, such as any of a rubber member and urethane, may be provided between the stator 41 and the housing 31. By providing the elastic member, vibrations of the stator 41 can be reduced. A heat release sheet or heat release paste (heat release grease, heat release gel, etc.) may be provided between the stator 41 and the housing 31. Thus, the heat dissipation property of the motor 40 can be improved, and the motor 40 can be prevented from overheating and vibrating.

Preferably, the outer diameter of the stator 41 is equal to or less than 100 mm. More preferably, the outer diameter is equal to or less than 90 mm. By making the stator 41 have an outer diameter of 100 mm or less, reduction in the size of the drive unit 20 can be further facilitated. The lower limit of the outer diameter of the stator 41 is, for example, 60 mm.

The rotor 42 has an annular shape that has a circular opening portion 44 at the rotation center, and is disposed inside the stator 41. Preferably, the inner diameter of the rotor 42 is equal to or larger than 30 mm. More preferably, the inner diameter is equal to or larger than 40 mm. By making the rotor 42 have an inner diameter of 30 mm or more, arrangement of the gears constituting the planetary gear mechanism 51 inside the opening portion 44 of the rotor 42 in the radial direction is facilitated. The upper limit of the inner diameter of the rotor 42 is, for example, 100 mm.

The motor shaft 43 is a cylindrical shaft-shaped member extending along the axial direction of the crankshaft 30 (left-right direction), and rotates integrally with the rotor 42. The motor shaft 43 is disposed such that its rotation axis is along the axial direction of the crankshaft 30. The motor shaft 43 is rotatably supported by the bearings 320, 321, and 322 provided in the housing 31, so as to be rotatable with respect to the housing 31.

The rotor 42 and the motor shaft 43 are fixed to each other by serrations. Note that the rotor 42 and the motor shaft 43 may be fixed by press-fitting, shrink-fitting, cool-fitting, or the like. When the rotor 42 and the motor shaft 43 are fixed, an elastic member, such as any of a rubber member and urethane, may be provided between the rotor 42 and the motor shaft 43.

The motor shaft 43 is disposed such that the central axis of rotation passes through the center of the internal gear 512 included in the planetary gear mechanism 51, described later, and penetrates through the internal gear 512. Tooth portions 43A to mesh with tooth portions 513A of the planetary gears 513 included in the planetary gear mechanism 51 are provided on the surface of the motor shaft 43. The motor shaft 43 constitutes the sun gear 511 of the planetary gear mechanism 51. Note that the tooth portions in this specification indicate tooth shapes provided in the surfaces of the gears, and encompass areas that do not mesh with the tooth portions of other gears.

As shown in FIG. 3, the planetary gear mechanism 51 includes: the motor shaft 43 as the sun gear 511; the internal gear 512 disposed on the concentric circle of the sun gear 511; the planetary gears 513 that mesh with the sun gear 511 and the internal gear 512; the planetary gear shafts 514; and the planetary carrier 515 as the output shaft.

The internal gear 512 has an annular shape. Tooth portions 512A are formed over the entire region of the inner peripheral surface. The internal gear 512 is non-rotatably fixed to the housing 31 by being fitted to the protruding portion 3111 of the housing 31.

The tooth portions 513A are formed over the entire periphery of each planetary gear 513, which meshes with the sun gear 511 and the internal gear 512. The planetary gear shafts 514 penetrate through the centers of the respective planetary gears 513, and freely rotatably hold these planetary gears 513. A bush 38 having L-shape in a sectional view taken in the axial direction is disposed outside of each planetary gear shaft 514 in the radial direction, and is configured such that the corresponding planetary gear shaft 514 can rotate. Note that the bearing 323 is not necessarily provided, and it may be the case that only the bush 38 is provided. The planetary carrier 515 supports the planetary gears 513 to allow them to orbit. The rotation axis of the planetary carrier 515 is positioned concentrically on the rotation axis of the sun gear 511. The planetary carrier 515 is rotatably supported by the bearing 323 provided in the housing 31. The bearing 323 is made up of, for example, a ball bearing.

As shown in FIG. 3, the rotor 42, and the tooth portions 43A of the motor shaft 43 (sun gear 511), the tooth portions 512A of the internal gear 512, and the tooth portions 513A of the planetary gears 513 are disposed at overlapping positions in the axial direction of the crankshaft 30. Accordingly, in the axial direction of the crankshaft 30, the size of the drive unit 20 can be reduced. Note that the tooth portions 43A of the motor shaft 43 (sun gear 511), the tooth portions 512A of the internal gear 512, and the tooth portions 513A of the planetary gears 513 may be disposed at positions overlapping the stator 41, instead of the rotor 42, in the axial direction of the crankshaft 30. Also in this case, the size of the drive unit 20 can be reduced.

At least parts of the tooth portions 43A of the motor shaft 43, the tooth portions 512A of the internal gear 512, and the tooth portions 513A of the planetary gears 513 are disposed inside the opening portion 44 of the rotor 42 in the radial direction. Accordingly, the drive unit 20 can be further reduced in size.

Metal gears and resin gears may be used as the gears that constitute the planetary gear mechanism 51. Use of resin gears can reduce the weight of the drive unit 20, and furthermore, can alleviate noise during traveling. The resin material may be for example, polyacetal, nylon 46, nylon 66, PEEK, or thermosetting resin, or may be super engineering plastic.

The gears that constitute the planetary gear mechanism 51 may be spur gears or helical gears. Use of helical gears can alleviate noise during traveling. Preferably, the gears that constitute the planetary gear mechanism 51 are lubricated with grease. Note that the gears that constitute the planetary gear mechanism 51 may be lubricated with lubrication oil. Each gear may have a non-arc shape resembling a gear shape.

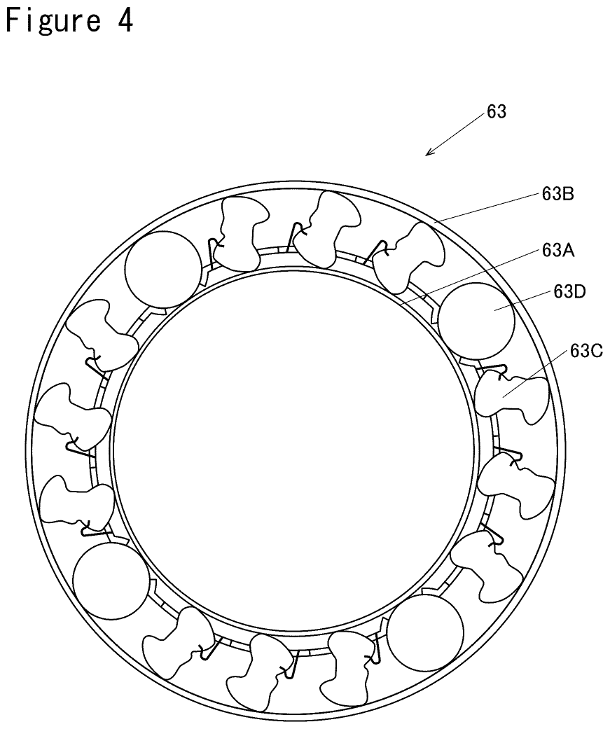

Next, by further reference to FIG. 4, the one-way clutch 63 is described. FIG. 4 is a sectional view of the one-way clutch 63.

As shown in FIG. 2, the one-way clutch 63 is disposed between the second human power transmission body 612 and the output body 62. The one-way clutch 63 is disposed closer to the sprocket 70 in the axial direction of the crankshaft 30 than the axial-direction center portion of the crankshaft 30. As described above, when the rotational power in the forward direction is applied to the second human power transmission body 612, the one-way clutch 63 transmits the rotational power to the output body 62. When the rotational power in the direction opposite to the forward direction is applied to the second human power transmission body 612, the one-way clutch 63 does not transmit the rotational power to the output body 62.

As shown in FIG. 4, the one-way clutch 63 includes an inner wheel body 63A, and an outer wheel body 63B that covers the outer peripheral portion of the inner wheel body 63A. The inner wheel body 63A is provided on the outer peripheral portion of the second human power transmission body 612. Note that the inner wheel body 63A may be provided integrally with the second human power transmission body 612. The outer wheel body 63B is provided on the inner peripheral portion of the output body 62. Note that the outer wheel body 63B may be formed integrally with the output body 62.

Sprags 63C as engagement pieces are disposed between the inner wheel body 63A and the outer wheel body 63B. That is, the one-way clutch 63 is a so-called sprag type one-way clutch. The sprags 63C are oriented in a stretching-out attitude between the inner wheel body 63A and the outer wheel body 63B, thus allowing transmission of the rotational power. On the other hand, the sprags 63C slide between the inner wheel body 63A and the outer wheel body 63B, thus preventing transmission of the rotational power. The shape of each sprag 63C is not limited to the form shown in FIG. 4, and may have, for example, a cylindrical shape.

Balls 63D as rolling bodies are further disposed between the inner wheel body 63A and the outer wheel body 63B. Consequently, when the outer wheel body 63B is rotatable with respect to the inner wheel body 63A1 i.e., when the rotational power cannot be transmitted, the one-way clutch 63 receives the radial load, functions as a bearing, and rotatably supports the second human power transmission body 612. As shown in FIG. 4, the one-way clutch 63 includes four balls 63D, and the four balls 63D are disposed at substantially regular intervals in the circumferential direction. Note that the rolling bodies are not limited to the balls 63D, and may be members having cylindrical shapes.

### Second Embodiment

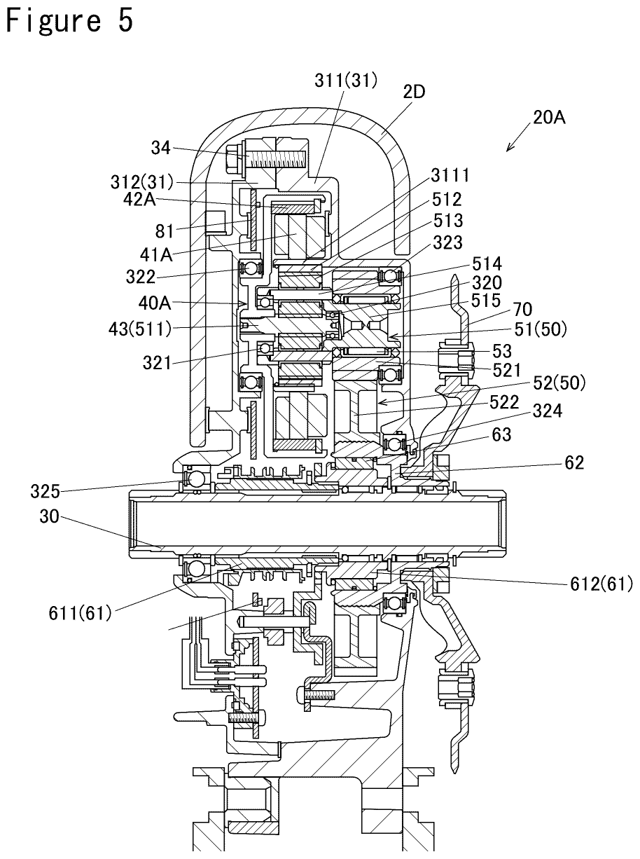

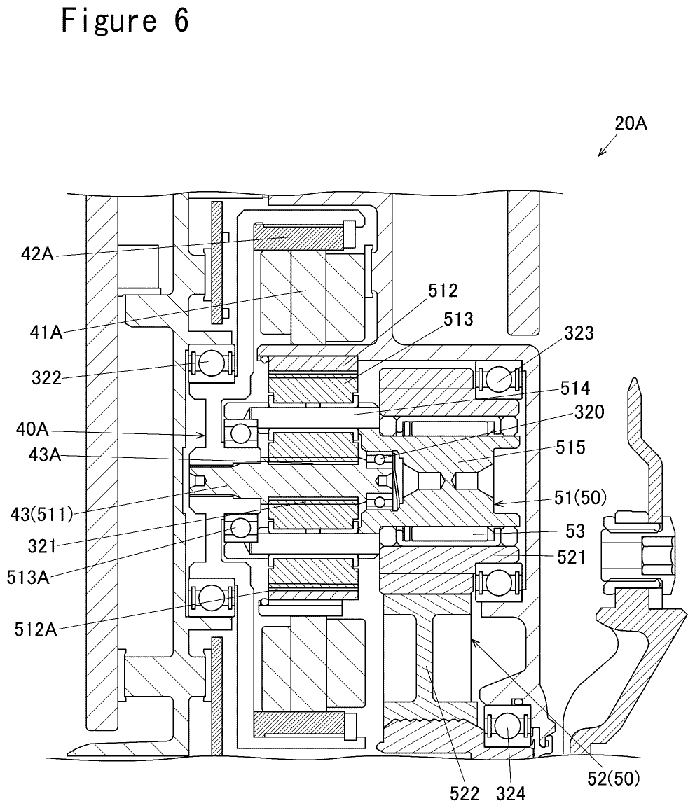

Hereinafter, by reference to FIGS. 5 and 6, a second embodiment of a drive unit in the present disclosure is described. FIG. 5 is a sectional view of a drive unit 20A according to the second embodiment. FIG. 6 shows an enlarged view of the vicinity of a motor 40A in FIG. 5. Hereinafter, components common to those in the first embodiment are assigned the same symbols, redundant description of these components is omitted, and the differences from the first embodiment are mainly described.

As shown in FIG. 5, the drive unit 20A includes: the motor 40A for applying rotational power for assisting the pedaling force on pedals 7; a housing 31 that houses the motor 40A; and a crankshaft 30 rotatably attached to the housing 31. Similar to the drive unit 20 in the first embodiment, the drive unit 20A is a so-called center unit type drive unit.

Similar to the drive unit 20 according to the first embodiment, the drive unit 20A further includes: a human power transmission body 61 that is attached so as to rotate integrally with the crankshaft 30, and is rotated by a human-power driving force; an output body 62 that outputs the rotational power of the motor 40A; a sprocket 70 that outputs the rotational power of the output body 62; and a power transmission mechanism 50 that decelerates the rotational power of the motor 40A, and transmits the power to the sprocket 70 via the output body 62.

Meanwhile, as shown in FIG. 6, the motor 40A of the drive unit 20A in the second embodiment is a so-called outer-rotor type motor, in which a rotor 42A is disposed outside a stator 41A in the radial direction. Use of the outer-rotor type facilitates outputting of higher torque than the inner-rotor type motor.

As shown in FIG. 6, the rotor 42A, and tooth portions 43A of a motor shaft 43, tooth portions 512A of an internal gear 512, and tooth portions 513A of planetary gears 513 are disposed at overlapping positions in the axial direction of the crankshaft 30. Accordingly, also in the case of using the outer-rotor type motor, the size of the drive unit 20A can be reduced in the axial direction of the crankshaft 30.

### Third Embodiment

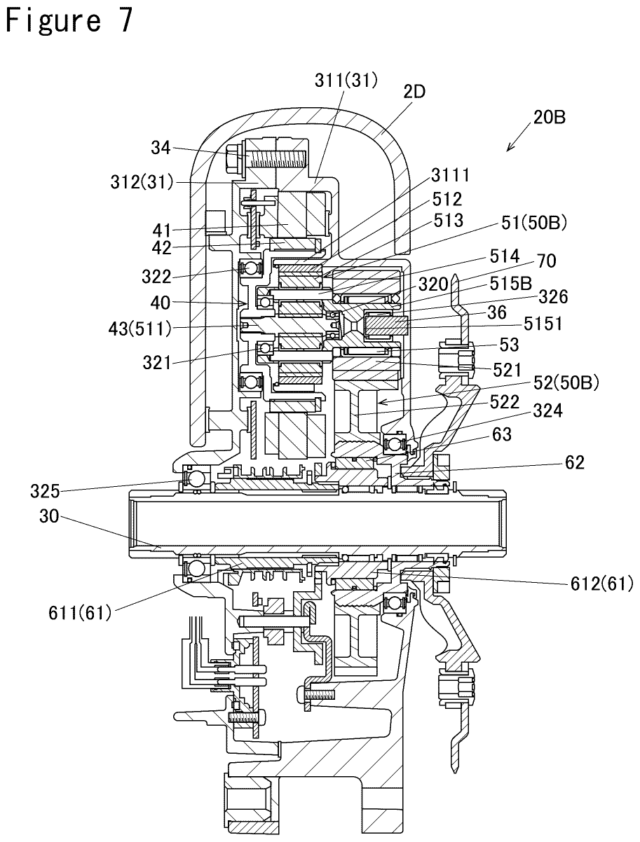

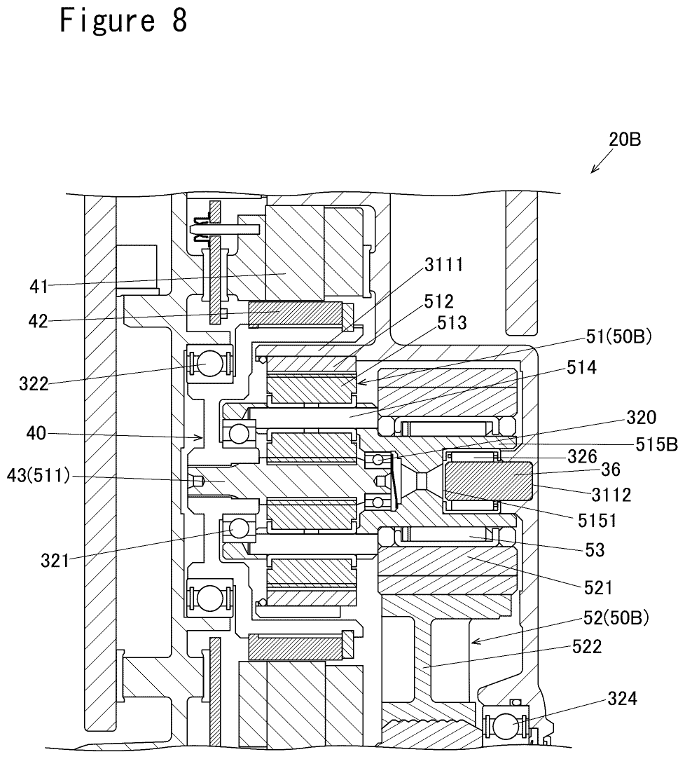

Next, by reference to FIGS. 7 and 8, a third embodiment of a drive unit in the present disclosure is described. FIG. 7 is a sectional view of a drive unit 20B according to the third embodiment. FIG. 8 shows an enlarged view of the vicinity of a motor 40 in FIG. 7. Hereinafter, components common to those in the first embodiment are assigned the same symbols, redundant description of these components is omitted, and the differences from the first embodiment are mainly described.

As shown in FIG. 7, similar to the drive unit 20 according to the first embodiment, the drive unit 20B includes: the motor 40 for applying rotational power for assisting the pedaling force on pedals 7; a housing 31 that houses the motor 40; and a crankshaft 30 rotatably attached to the housing 31.

The drive unit 20B further includes: a human power transmission body 61 that is attached so as to rotate integrally with the crankshaft 30, and is rotated by a human-power driving force; an output body 62 that outputs the rotational power of the motor 40; a sprocket 70 that outputs the rotational power of the output body 62; and a power transmission mechanism 50B that decelerates the rotational power of the motor 40, and transmits the power to the sprocket 70 via the output body 62. The power transmission mechanism 50B is made up of two stages of speed reduction mechanisms, and includes: a planetary gear mechanism 51 that is a first-stage speed reduction mechanism; and a second speed reduction mechanism 52 that is a second-stage speed reduction mechanism.

Meanwhile, as shown in FIG. 8, the configuration of a planetary carrier 515B included in the planetary gear mechanism 51 is different from that of the planetary carrier 515 of the drive unit 20 in the first embodiment. Specifically, the planetary carrier 515B includes a hollow portion 5151 centered at the rotation axis, and a protrusion member 36 and a bearing 326 are disposed in the hollow portion 5151.

The protrusion member 36 is fitted into a concavity 3112 formed in a first divided body 311, and is non-rotatably fixed to the first divided body 311. No particular limitation is imposed on the material of the protrusion member 36. However, for example, this member is made of a metal material containing iron or aluminum as a main component. By providing the protrusion member 36, the rotation of the planetary carrier 515B can be stabilized.

The bearing 326 rotatably supports the planetary carrier 515B at the housing 31. By providing the bearing 326 in the hollow portion 5151 of the planetary carrier 515B, the size of the drive unit 20B can be reduced.

### Fourth Embodiment

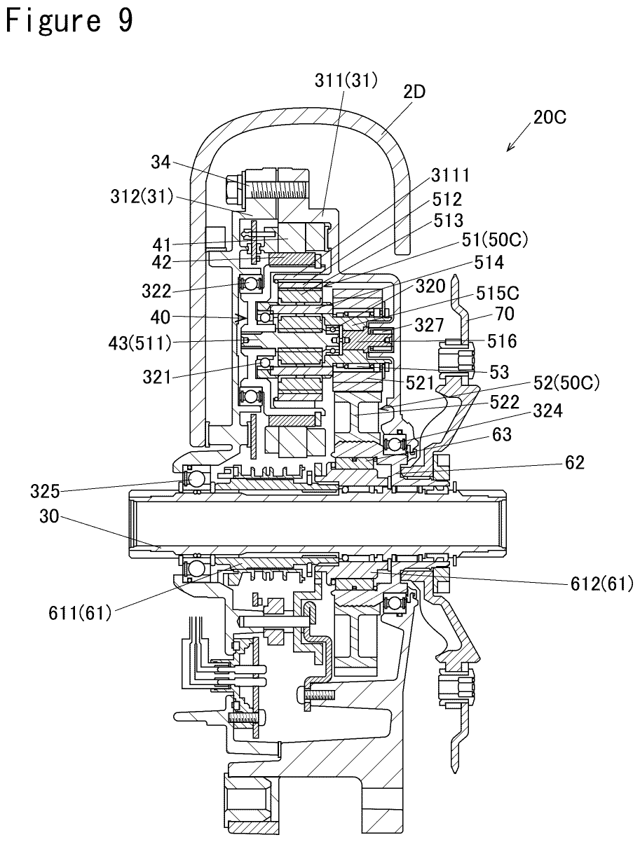

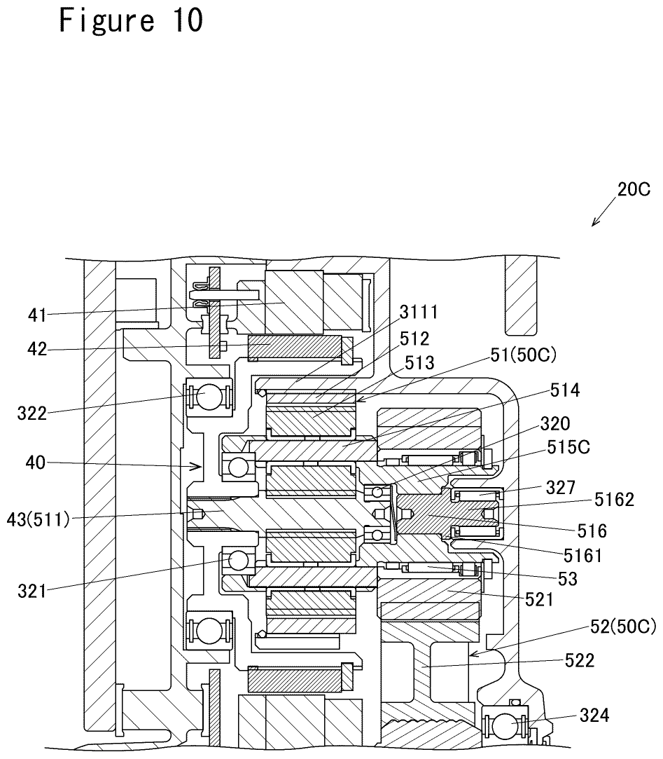

Next, by reference to FIGS. 9 and 10, a fourth embodiment of a drive unit in the present disclosure is described. FIG. 9 is a sectional view of a drive unit 20C according to the fourth embodiment. FIG. 10 shows an enlarged view of the vicinity of a motor 40 in FIG. 9. Hereinafter, components common to those in the first embodiment are assigned the same symbols, redundant description of these components is omitted, and the differences from the first embodiment are mainly described.

As shown in FIG. 9, similar to the drive unit 20 according to the first embodiment, the drive unit 20C includes: the motor 40 for applying rotational power for assisting the pedaling force on pedals 7; a housing 31 that houses the motor 40; and a crankshaft 30 rotatably attached to the housing 31.

The drive unit 20C further includes: a human power transmission body 61 that is attached so as to rotate integrally with the crankshaft 30, and is rotated by a human-power driving force; an output body 62 that outputs the rotational power of the motor 40; a sprocket 70 that outputs the rotational power of the output body 62; and a power transmission mechanism 50C that decelerates the rotational power of the motor 40, and transmits the power to the sprocket 70 via the output body 62. The power transmission mechanism 50C is made up of two stages of speed reduction mechanisms, and includes: a planetary gear mechanism 51 that is a first-stage speed reduction mechanism; and a second speed reduction mechanism 52 that is a second-stage speed reduction mechanism.

As shown in FIG. 10, the power transmission mechanism 50C of the drive unit 20C includes an output member 516 that meshes with a planetary carrier 515C constituting the output shaft of the planetary gear mechanism 51. The output member 516 is a solid cylindrical member that extends in the axial direction of the crankshaft 30. The output member 516 is disposed such that the rotation axis of the output member 516 is positioned concentrically on the rotation axis of the planetary carrier 515C. By providing the output member 516, the rotation of the planetary carrier 515C can be stabilized.

A protruding portion 5161 that protrudes outward in the radial direction from the output member 516 is formed over the entire periphery of the output member 516 at the axial-direction center portion of the output member 516. The output member 516 and the planetary carrier 515C mesh with each other in the left region of the protruding portion 5161. That is, the output member 516 and the planetary carrier 515C do not mesh with each other in the right region of the protruding portion 5161.

The output member 516 includes a small-diameter portion 5162 formed to have a smaller diameter than the other portion, in the right region of the protruding portion 5161. A bearing 327 (third bearing) that rotatably supports the output member 516 at the housing 31 is disposed outside of the small-diameter portion 5162 in the radial direction. Accordingly, the output member 516 can be rotatably supported at the housing 31 without increasing the size of the drive unit 20C. The bearing 327 (third bearing) and a first transmission gear 521 are disposed at positions overlapping in the axial direction of the crankshaft 30. Accordingly, reduction in size of the drive unit 20C can be facilitated.

### Fifth Embodiment

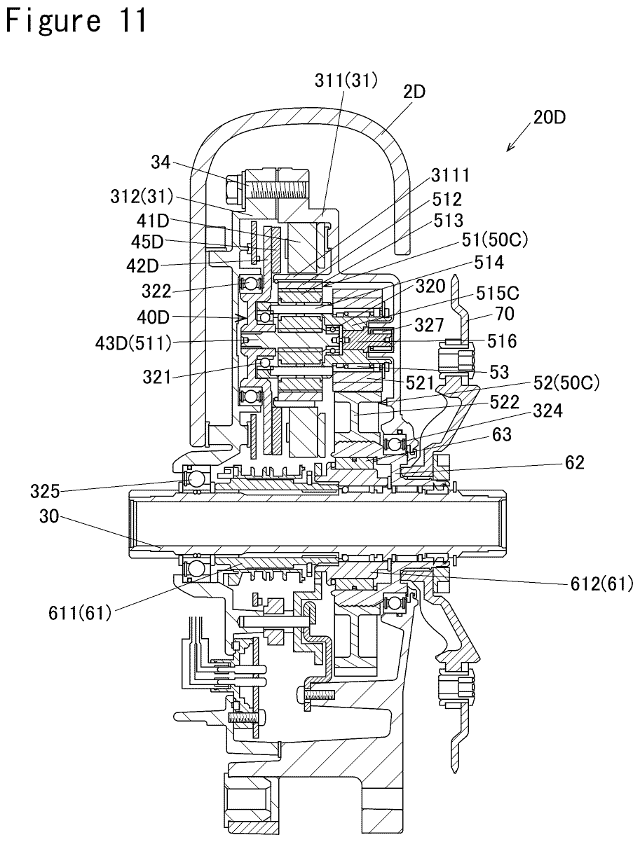

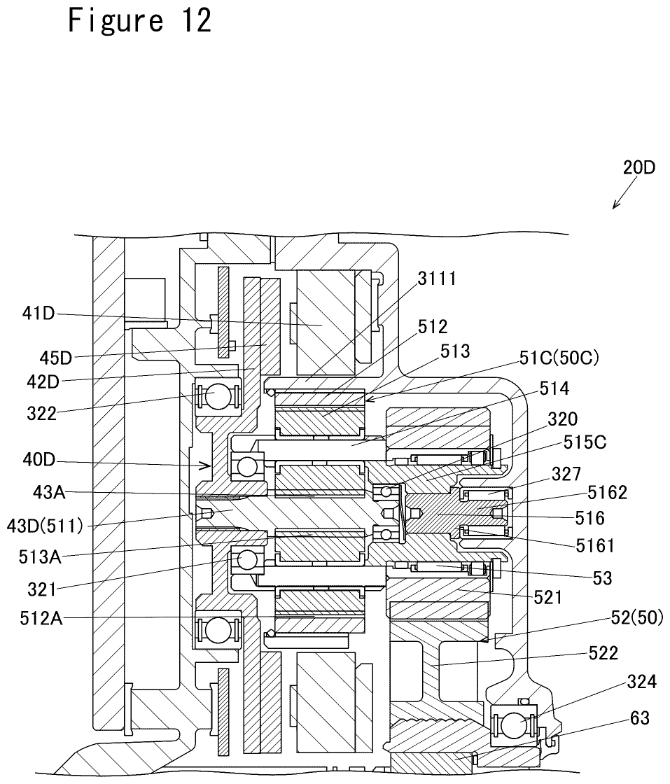

Hereinafter, by reference to FIGS. 11 and 12, a fifth embodiment of a drive unit in the present disclosure is described. FIG. 11 is a sectional view of a drive unit 20D according to the fifth embodiment. FIG. 12 shows an enlarged view of the vicinity of a motor 40D in FIG. 11. Hereinafter, components common to those in the fourth embodiment are assigned the same symbols, redundant description of these components is omitted, and the differences from the fourth embodiment are mainly described.

As shown in FIG. 11, the drive unit 20D includes: the motor 40D for applying rotational power for assisting the pedaling force on pedals 7; a housing 31 that houses the motor 40A; and a crankshaft 30 rotatably attached to the housing 31. Similar to the drive unit 20C in the fourth embodiment, the drive unit 20D is a so-called center unit type drive unit.

Similar to the drive unit 20C according to the fourth embodiment, the drive unit 20D further includes: a human power transmission body 61 that is attached so as to rotate integrally with the crankshaft 30, and is rotated by a human-power driving force; an output body 62 that outputs the rotational power of the motor 40D; a sprocket 70 that outputs the rotational power of the output body 62; and a power transmission mechanism 50C that decelerates the rotational power of the motor 40D, and transmits the power to the sprocket 70 via the output body 62.

Meanwhile, as shown in FIG. 12, in the drive unit 20D according to the fifth embodiment, the configuration of the motor 40D is different from that of the drive unit 20C according to the fourth embodiment. Specifically, the motor 40D includes: a motor shaft 43D that is an output shaft; a stator 41D fixed to the housing 31; and a rotor 42D that is fixed to the motor shaft 43D and includes magnets 45D. The rotor 42D is disposed so as to face the stator 41D in a direction along the rotation axis of the motor shaft 43D. That is, the motor 40D is a so-called axial gap motor. Use of the axial gap motor can reduce the size of the motor 40D, and facilitates reduction in the size of the drive unit 20D, in comparison with an inner-rotor type or an outer-rotor type motor.

In the present embodiment, the rotor 42D is disposed only on one side (left side) of the stator 41D in the direction along the rotation axis of the motor shaft 43D. Accordingly, the motor 40D can be reduced in size, which facilitates reduction in the size of the drive unit 20D. Note that the rotor 42D may be disposed on the opposite sides of the stator 41D in the direction along the rotation axis of the motor shaft 43D.

The motor shaft 43D is rotatably supported by bearings 320 and 321 at the housing 31. The bearings 320 and 321 are disposed separately from each other in the direction along the rotation axis of the motor shaft 43D.

As shown in FIG. 12, the stator 41D, and tooth portions 43A of the motor shaft 43D, tooth portions 512A of an internal gear 512, and tooth portions 513A of planetary gears 513 are disposed at overlapping positions in the axial direction of the crankshaft 30. Accordingly, also in the case of using the axial gap motor, the size of the drive unit 20D can be reduced in the axial direction of the crankshaft 30.

### Sixth Embodiment

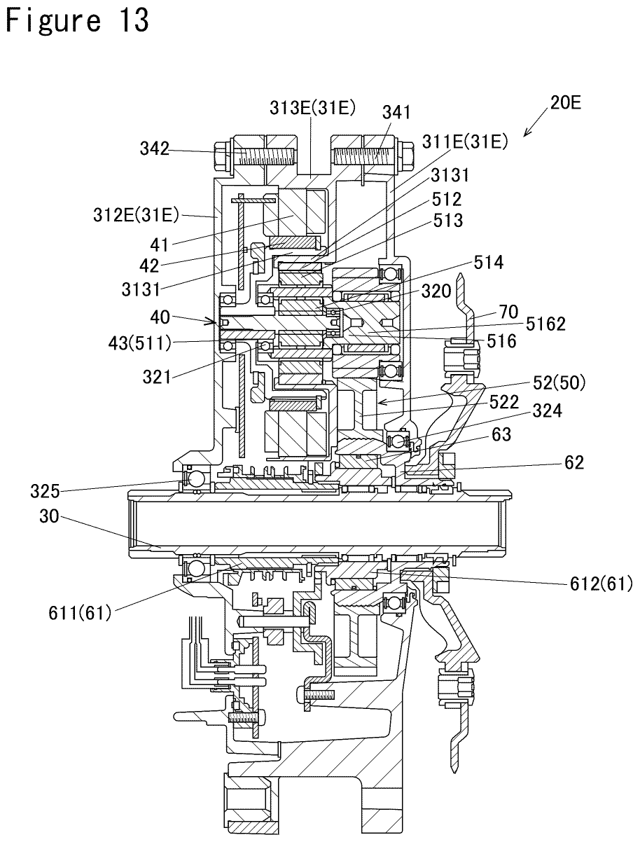

Next, by reference to FIG. 13, a sixth embodiment of a drive unit in the present disclosure is described. FIG. 13 is a sectional view of a drive unit 20E according to the sixth embodiment. Hereinafter, components common to those in the first embodiment are assigned the same symbols, redundant description of these components is omitted, and the differences from the first embodiment are mainly described.

As shown in FIG. 13, the drive unit 20E includes: a motor 40 for applying rotational power for assisting the pedaling force on pedals 7; a housing 31E that houses the motor 40; and a crankshaft 30 rotatably attached to the housing 31E.

Similar to the drive unit 20 according to the first embodiment, the drive unit 20E further includes: a human power transmission body 61 that is attached so as to rotate integrally with the crankshaft 30, and is rotated by a human-power driving force; an output body 62 that outputs the rotational power of the motor 40; a sprocket 70 that outputs the rotational power of the output body 62; and a power transmission mechanism 50 that decelerates the rotational power of the motor 40, and transmits the power to the sprocket 70 via the output body 62.

The housing 31E includes: a first divided body 311E that constitutes a right outer shell of the housing 31E; a second divided body 312E that constitutes a left outer shell of the housing 31E; and a third divided body 313E that intervenes between the first divided body 311E and the second divided body 312E. The first divided body 311E and the third divided body 313E are joined with a fastener member 341, such as a bolt, and the second divided body 312E and the third divided body 313E are joined with a fastener member 342, such as a bolt. The housing 31E is made up of these three divided bodies, which can facilitate the configuration of each divided body, and improves productivity. Note that the number of the divided bodies constituting the housing may be four or more. The space formed in the housing 31E may be closed, or not closed.

The third divided body 313E includes a protruding portion 3131 that protrudes to the left. An internal gear 512 included in a planetary gear mechanism 51 is fitted to the protruding portion 3131.

### Seventh Embodiment

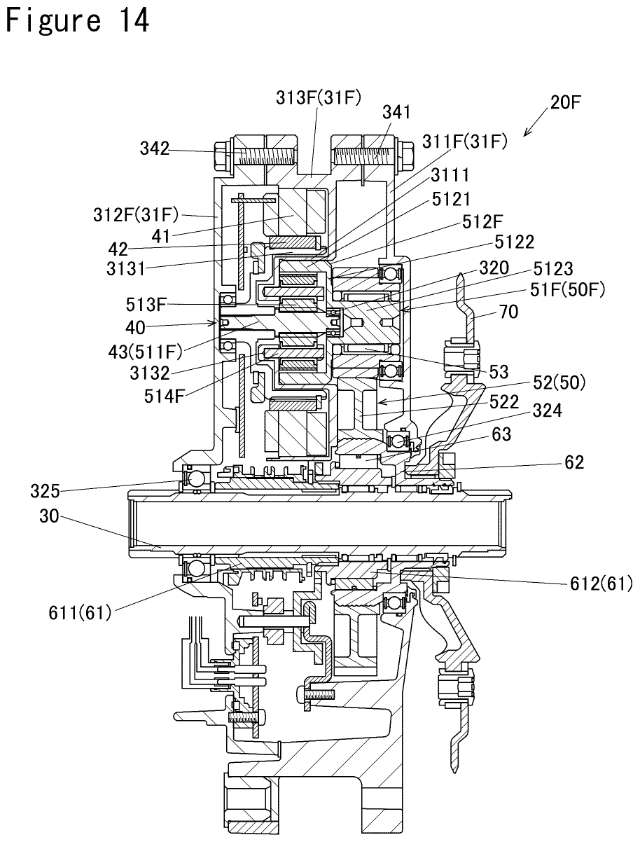

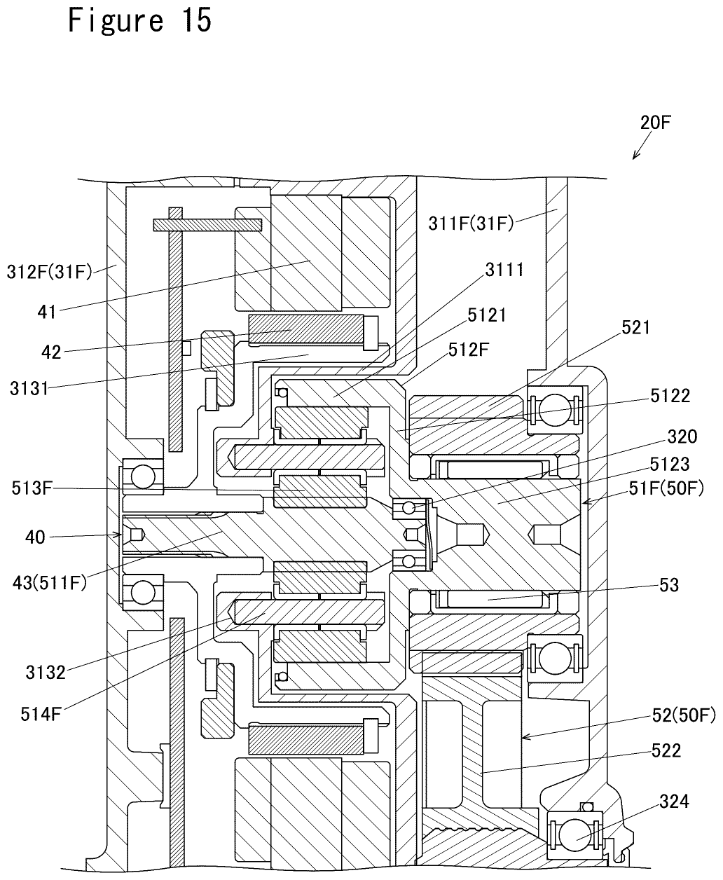

Next, by reference to FIGS. 14 and 15, a seventh embodiment of a drive unit in the present disclosure is described. FIG. 14 is a sectional view of a drive unit 20F according to the seventh embodiment. FIG. 15 shows an enlarged view of the vicinity of a motor 40 in FIG. 14. Hereinafter, components common to those in the first embodiment are assigned the same symbols, redundant description of these components is omitted, and the differences from the first embodiment are mainly described.

As shown in FIG. 14, the drive unit 20F includes: the motor 40 for applying rotational power for assisting the pedaling force on pedals 7; a housing 31F that houses the motor 40; and a crankshaft 30 rotatably attached to the housing 31F. Similar to the housing 31E in the fifth embodiment, the housing 31F is made up of three divided bodies: a first divided body 311F, a second divided body 312F, and a third divided body 313F.

The drive unit 20F further includes: a human power transmission body 61 that is attached so as to rotate integrally with the crankshaft 30, and is rotated by a human-power driving force; an output body 62 that outputs the rotational power of the motor 40; a sprocket 70 that outputs the rotational power of the output body 62; and a power transmission mechanism 50F that decelerates the rotational power of the motor 40, and transmits the power to the sprocket 70 via the output body 62. The power transmission mechanism 50F is made up of two stages of speed reduction mechanisms, and includes: a planetary gear mechanism 51F that is a first-stage speed reduction mechanism; and a second speed reduction mechanism 52 that is a second-stage speed reduction mechanism.

As shown in FIG. 15, the planetary gear mechanism 51F includes: a motor shaft 43 as a sun gear 511F; an internal gear 512F that is disposed on the concentric circle of the sun gear 511 and serves as an output shaft; planetary gears 513F that mesh with the sun gear 511F and the internal gear 512F; and planetary gear shafts 514F as fixed shafts.

The internal gear 512F includes: an annular portion 5121 that has an annular shape, and has tooth portions that mesh with the planetary gears 513F and are formed in the inner peripheral surface; a connection portion 5122 that is connected to the annular portion 5121 and extends inward in the radial direction; and a cylindrical body portion 5123 that is connected to the connection portion 5122 and extends along the axial direction of the crankshaft 30. The annular portion 5121, the connection portion 5122, and the cylindrical body portion 5123 rotate integrally.

The rotational power of the motor 40 is transmitted to a first transmission gear 521 included in the second speed reduction mechanism 52, via the cylindrical body portion 5123. Note that a one-way clutch 53 is provided between the cylindrical body portion 5123 and the first transmission gear 521.

The planetary gear shafts 514F are respectively fitted into depressed portions 3132 formed in the third divided body 313F. Accordingly, the planetary gear shafts 514F are non-rotatably fixed to the housing 31F. Note that in the example shown in FIGS. 14 and 15, the planetary gear shafts 514F are fixed to the third divided body 313F. Alternatively, the planetary gear shafts 514F may be fixed to the second divided body 312F. The housing 31F is made up of three divided bodies in the example shown in FIGS. 14 and 15, but may be made up of two divided bodies, instead.

### Eighth Embodiment

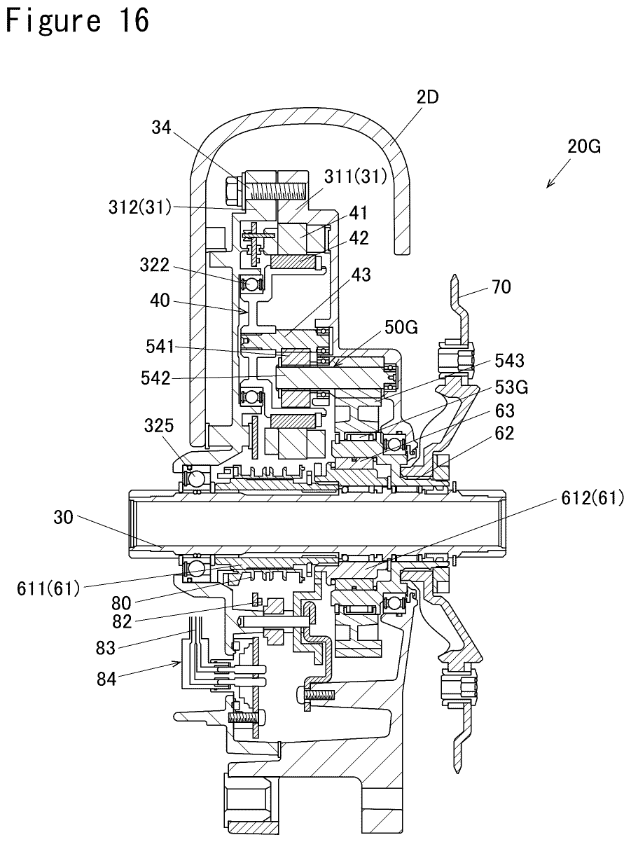

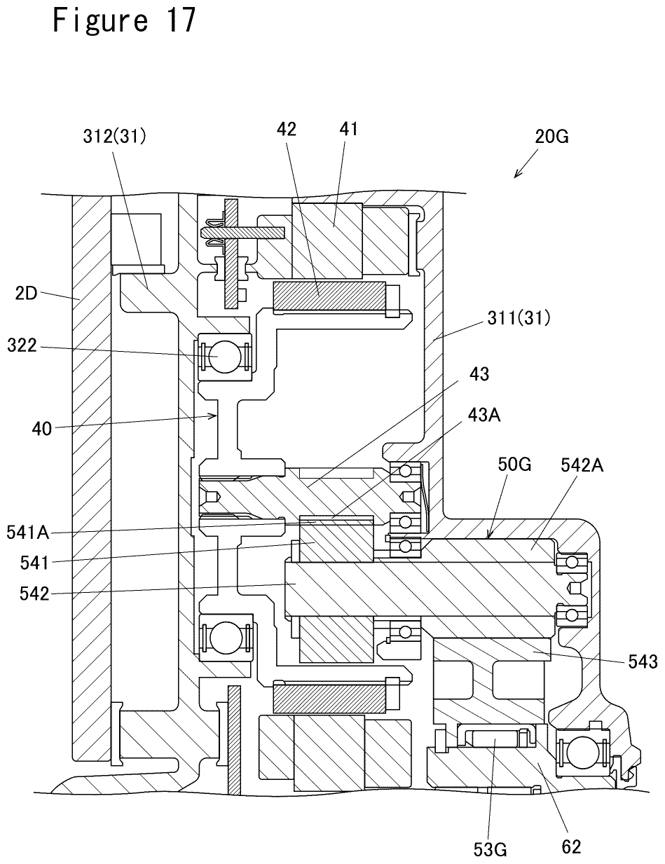

Next, by reference to FIGS. 16 and 17, an eighth embodiment of a drive unit in the present disclosure is described. FIG. 16 is a sectional view of a drive unit 20G according to the eighth embodiment. FIG. 17 shows an enlarged view of the vicinity of a motor 40 in FIG. 16. Hereinafter, components common to those in the first embodiment are assigned the same symbols, redundant description of these components is omitted, and the differences from the first embodiment are mainly described.

As shown in FIG. 16, similar to the drive unit 20 according to the first embodiment, the drive unit 20G includes: the motor 40 for applying rotational power for assisting the pedaling force on pedals 7; a housing 31 that houses the motor 40; and a crankshaft 30 rotatably attached to the housing 31.

The drive unit 20G further includes: a human power transmission body 61 that is attached so as to rotate integrally with the crankshaft 30, and is rotated by a human-power driving force; an output body 62 that outputs the rotational power of the motor 40; a sprocket 70 that outputs the rotational power of the output body 62; and a power transmission mechanism 50G that decelerates the rotational power of the motor 40, and transmits the power to the sprocket 70 via the output body 62.

As shown in FIG. 17, the power transmission mechanism 50G is a parallel shaft gear mechanism that meshes with the motor shaft 43 as the output shaft of the motor 40, and includes a first transmission gear 541 having a rotation axis disposed in parallel with the rotation axis of the motor shaft 43. The power transmission mechanism 50G is a mechanism that includes the first transmission gear 541, a gear shaft 542, and a second transmission gear 543, and transmits the rotational power of the motor 40 to the output body 62 via the first transmission gear 541, the gear shaft 542, and the second transmission gear 543.

The first transmission gear 541 is disposed inside an opening portion of a rotor 42 in the radial direction. The first transmission gear 541 includes tooth portions 541A that mesh with tooth portions 43A provided on the motor shaft 43. The rotor 42, the tooth portions 43A of the motor shaft 43, and the tooth portions 541A of the first transmission gear 541 are disposed at positions overlapping in the axial direction of the crankshaft 30. Accordingly, the size of the drive unit 20G can be reduced in the axial direction of the crankshaft 30. Splines or serrations to be fitted to the gear shaft 542 are formed in the inner peripheral surface of the first transmission gear 541. Note that the first transmission gear 541 may be subjected to insert molding on the gear shaft 542.

The gear shaft 542 is disposed along the axial direction of the crankshaft 30. The gear shaft 542 rotates integrally with the first transmission gear 541. While no specific limitation is imposed on the length of the gear shaft 542, the length ranges, for example, from 5% to 50%, inclusive, of the length of the crankshaft 30 in the axial direction. Tooth portions 542A are formed on the right side of the gear shaft 542.

The second transmission gear 543 meshes with the tooth portions 542A formed on the right side of the gear shaft 542. The rotation axis of the second transmission gear 543 is concentrically positioned on the rotation axis of the crankshaft 30.

A one-way clutch 53G is provided between the second transmission gear 543 and the output body 62. That is, the rotational power of the motor 40 output from the second transmission gear 543 is transmitted to the output body 62 via the one-way clutch 53G.

When the rotational power in the forward direction is applied to the second transmission gear 543, the one-way clutch 53G transmits the rotational power to the output body 62. When the rotational power in the direction opposite to the forward direction is applied to the second transmission gear 543, the one-way clutch 53G does not transmit the rotational power to the output body 62. When the rotational power in the forward direction is applied to the output body 62 via the human power transmission body 61, the one-way clutch 53G does not transmit the rotational power to the second transmission gear 543.

### Ninth Embodiment

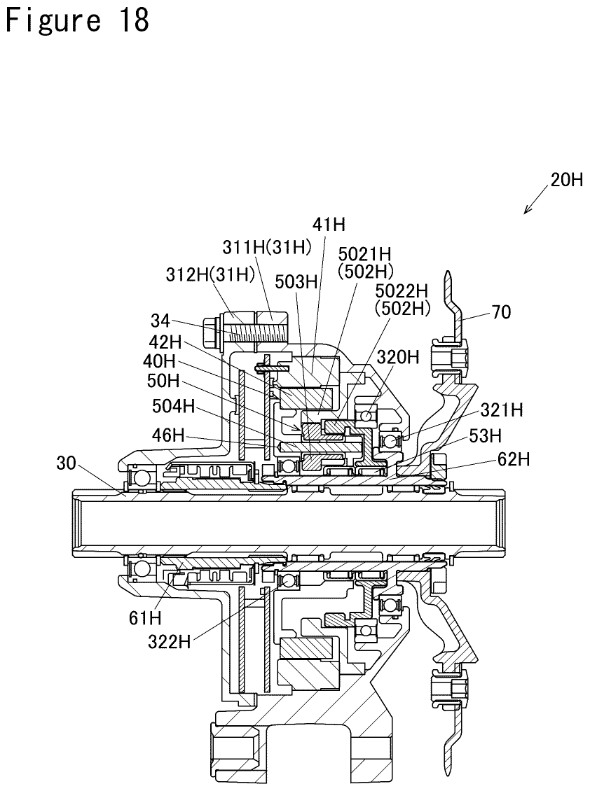

Next, by reference to FIG. 18, a ninth embodiment of a drive unit in the present disclosure is described. FIG. 18 is a sectional view of a drive unit 20H according to the ninth embodiment. Hereinafter, components common to those in the first embodiment are assigned the same symbols, redundant description of these components is omitted, and the differences from the first embodiment are mainly described.

As shown in FIG. 18, the drive unit 20H includes: a motor 40H for applying rotational power for assisting the pedaling force on pedals 7; a housing 31H that houses the motor 40H; and a crankshaft 30 rotatably attached to the housing 31H.

The drive unit 20H further includes: a human power transmission body 61H that is attached so as to rotate integrally with the crankshaft 30, and is rotated by a human-power driving force; an output body 62H that outputs the rotational power of the motor 40H; a sprocket 70 that outputs the rotational power of the output body 62H; and a power transmission mechanism 50H that decelerates the rotational power of the motor 40H, and transmits the power to the sprocket 70 via the output body 62H.

The motor 40H includes a stator 41H, and a rotor 42H having an opening portion at the rotation center. In the present embodiment, the motor 40H includes no motor shaft rotating integrally with the rotor 42H. Note that the motor 40H may be an outer-rotor type or axial gap type motor. Depressed portions 46H into which planetary gear shafts 504H included in the power transmission mechanism 50H described later are respectively fitted are formed in the motor 40H.

Similar to the first embodiment, the housing 31H includes: a first divided body 311H that constitutes the right half of the housing 31H; and a second divided body 312H that constitutes the left half of the housing 31H. The first divided body 311H and the second divided body 312H are joined together with a fastener member 34, such as a bolt. Splines or serrations to be fitted to a first internal gear 5021H included in the power transmission mechanism 50H described later are formed in the inner surface of the first divided body 311H. Note that the first divided body 311H and the first internal gear 5021H may be screwed together with a screw.

The power transmission mechanism 50H is a planetary gear mechanism that includes an internal gear 502H, planetary gears 503H, and planetary gear shafts 504H.

The power transmission mechanism 50H is a mechanism that decelerates the rotational power of the motor 40H, and transmits the power to the sprocket 70 via the output body 62H. In the present embodiment, the planetary gear 503H is a stepped planetary gear that includes two gears having different outer diameters.

The internal gear 502H includes the first internal gear 5021H and a second internal gear 5022H. The first internal gear 5021H meshes with a large-diameter portion of the planetary gear 503H, and the second internal gear 5022H meshes with a small-diameter portion of the planetary gear 503H.

The first internal gear 5021H is fitted to the inner surface of the first divided body 311H constituting the housing 31H, thus being non-rotatably fixed to the housing 31H. That is, the first internal gear 5021H functions as a fixed shaft of the planetary gear mechanism.

Meanwhile, the second internal gear 5022H functions as the output shaft of the planetary gear mechanism, and the rotational power of the second internal gear 5022H is transmitted to the output body 62H via a one-way clutch 53H. The second internal gear 5022H is rotatably supported by a bearing 320H at the housing 31H.

As described above, the planetary gear 503H is a stepped planetary gear that includes the two gears having different outer diameters. The planetary gear shafts 504H penetrate through the centers of the respective planetary gears 503H, and hold these planetary gears 503H in a freely rotatably manner. The left end of the planetary gear shaft 504H is fitted into the depressed portion 46H formed in the motor 40H.

Accordingly, the planetary gear shaft 504H rotates integrally with the motor 40H. Note that the planetary gear 503H is not necessarily a stepped one, and may be made up of a single gear. In this case, the gear inner and outer diameters of the first internal gear 5021H and the second internal gear 5022H are substantially the same. However, by making the addendum modification coefficients in gear data different, the numbers of tooth portions of the gears can be changed. In the case of this configuration, the shape of the planetary gear 503H is simplified, which improves the assemblability of the drive unit 20H.

The human power transmission body 61H is a cylindrical member that extends along the axial direction of the crankshaft 30, and is disposed on the outer peripheral portion of the crankshaft 30 in the housing 31H. The human power transmission body 61H rotates integrally with the crankshaft 30. In the present embodiment, the human power transmission body 61H is made up of a single member. Similar to the first embodiment, it may be made up of multiple members.

The output body 62H is a cylindrical member that extends along the axial direction of the crankshaft 30, and is disposed on the outer peripheral portion of the crankshaft 30. The rotation axis of the output body 62H is concentrically positioned on the rotation axis of the crankshaft 30. The output body 62H is rotatably supported by bearings 321H and 322H at the housing 31H. The deceleration scheme as in the drive unit 20H in the present embodiment tends to have a low power transmission efficiency at a small number of revolutions, and generate heat. Preferably, oil lubrication for facilitating dissipation of the generated heat is adopted accordingly. The oil lubrication can reduce the friction coefficients of the tooth portions of the gears, and reduce the heat generation at the same time. Furthermore, the oil lubrication makes oil adhere to the housing 31H, which can efficiently dissipate heat from the housing 31H. By applying the oil on the motor 40H, the motor 40H can efficiently dissipate heat.

### Tenth Embodiment

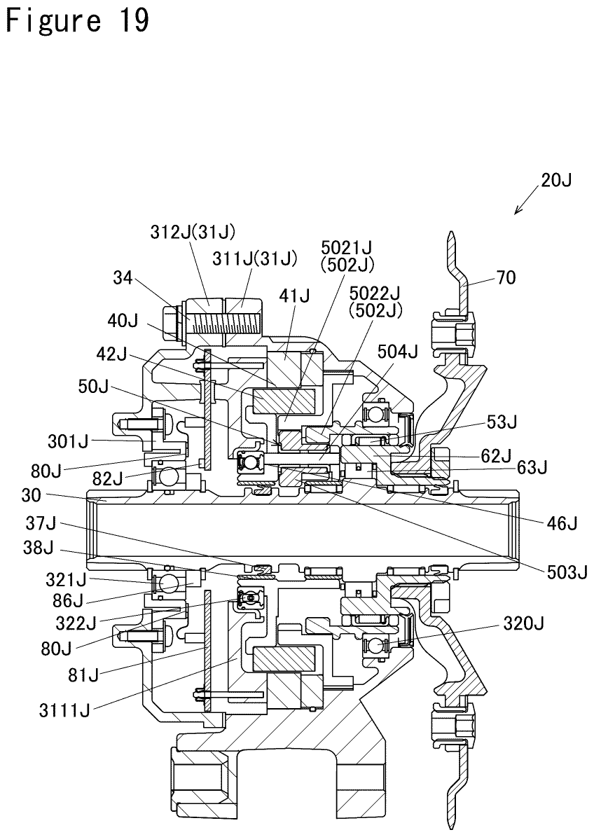

Next, by reference to FIG. 19, a tenth embodiment of a drive unit in the present disclosure is described. FIG. 19 is a sectional view of a drive unit 20J according to the tenth embodiment. Hereinafter, components common to those in the first embodiment are assigned the same symbols, redundant description of these components is omitted, and the differences from the first embodiment are mainly described.

As shown in FIG. 19, the drive unit 20J includes: a motor 40J for applying rotational power for assisting the pedaling force on pedals 7; a housing 31J that houses the motor 40J; and a crankshaft 30 rotatably attached to the housing 31J.

The drive unit 20J further includes: an output body 62J that outputs the rotational power of the motor 40J; a sprocket 70 that outputs the rotational power of the output body 62J; and a power transmission mechanism 50J that decelerates the rotational power of the motor 40J, and transmits the power to the sprocket 70 via the output body 62J. Note that the drive unit 20J includes no human power transmission body, and the rotational power of the crankshaft 30 is directly transmitted to the output body 62J. Absence of the human power transmission body allows the components constituting the power transmission mechanism 50J to be disposed closer to the crankshaft 30, and facilitates reduction in the size of the drive unit 20J.

The motor 40J includes a stator 41J, and a rotor 42J having an opening portion at the rotation center. In the present embodiment, the motor 40J includes no motor shaft rotating integrally with the rotor 42J. Note that the motor 40J may be an outer-rotor type motor or an axial gap type motor. Depressed portions 46J into which planetary gear shafts 504J included in the power transmission mechanism 50J described later are respectively fitted are formed in the motor 40J.

Similar to the first embodiment, the housing 31J includes: a first divided body 311J that constitutes the right half of the housing 31J; and a second divided body 312J that constitutes the left half of the housing 31J. The first divided body 311J and the second divided body 312J are joined together with a fastener member 34, such as a bolt. Splines or serrations to be fitted to a first internal gear 5021J included in the power transmission mechanism 50J described later are formed in the inner surface of the first divided body 311J. The first divided body 311J includes a partition wall 3111J that extends toward the crankshaft 30. The partition wall 3111J is in contact with a bearing 322J on its outer side in the radial direction, and holds the bearing 322J. The partition wall 3111J may be made up of a component (e.g., an insulator) of the stator 41J.

The inside of the housing 31J is partitioned by the partition wall 3111J. The motor 40J and the power transmission mechanism 50J are disposed in the space on the right side of the partition wall 3111J. A control board 81J is disposed in the space on the left side of the partition wall 3111J. Here, the space on the right side of the partition wall 3111J stores lubrication oil. Accordingly, the gears constituting the power transmission mechanism 50J are lubricated, and the durability and quiet performance are improved. Note that the space in which the control board 81J is disposed is provided with no lubrication oil.

Preferably, an elastic member, such as an O-ring, is provided between the stator 41J and the housing 31J (first divided body 311J) in view of preventing leakage of the lubrication oil stored in the space on the right side of the partition wall 3111J. Preferably, an oil seal 37J is provided on the outer peripheral portion of the crankshaft 30. Preferably, a bush 38J made of metal, such as iron, is provided between the oil seal 37J and the motor 40J. This can prevent leakage of the lubrication oil stored in the space on the right side of the partition wall 3111J, and reduce abrasion due to contact of a lip part of the oil seal 37J with the motor 40J.

The power transmission mechanism 50J is a planetary gear mechanism that includes an internal gear 502J, planetary gears 503J, and planetary gear shafts 504J. The power transmission mechanism 50J is a mechanism that decelerates the rotational power of the motor 40J, and transmits it to the sprocket 70 via the output body 62J. In the present embodiment, the planetary gear 503J is a stepped planetary gear that includes two gears having different outer diameters.

The internal gear 502J includes a first internal gear 5021J and a second internal gear 5022J. The first internal gear 5021J meshes with a large-diameter portion of the planetary gear 503J, and the second internal gear 5022J meshes with a small-diameter portion of the planetary gear 503J.

The first internal gear 5021J is fitted to the inner surface of the first divided body 311J included in the housing 31J, thus being non-rotatably fixed to the housing 31J. That is, the first internal gear 5021J functions as a fixed shaft of the planetary gear mechanism.

On the other hand, the second internal gear 5022J functions as the output shaft of the planetary gear mechanism, and the rotational power of the second internal gear 5022J is transmitted to the output body 62J via a one-way clutch 53J. The second internal gear 5022J is rotatably supported by a bearing 320J at the housing 31J.

As described above, the planetary gear 503J is a stepped planetary gear that includes the two gears having different outer diameters. The planetary gear shafts 504J penetrate through the centers of the respective planetary gears 503J, and hold these planetary gears 503J in a freely rotatable manner. The left end of the planetary gear shaft 504J is fitted into the depressed portion 46J formed in the motor 40J. Accordingly, the planetary gear shaft 504J rotates integrally with the motor 40J. The bearing provided between the planetary gear 503J and the planetary gear shaft 504J may be a ball bearing or a sliding bearing.

The output body 62J is a cylindrical member that extends along the axial direction of the crankshaft 30, and is disposed on the outer peripheral portion of the crankshaft 30. The rotation axis of the output body 62J is concentrically positioned on the rotation axis of the crankshaft 30. In the present embodiment, as described above, no human power transmission body is provided. Accordingly, the rotational power of the crankshaft 30 is transmitted to the output body 62J via the one-way clutch 63J. The one-way clutch 63J also functions as a bearing, and rotatably supports the output body 62J.

The drive unit 20J is provided with a plurality of (e.g., two to four) strain sensors 80J as torque detecting portions. The strain sensors 80J are disposed on the outer side of the bearing 321J in the radial direction, and measure a load applied to the bearing 321J. The bearing 321J supports the crankshaft 30 on the opposite side of a site where the sprocket 70 is provided, in the axial direction of the crankshaft 30, and is resistant to being affected by the chain tension accordingly. Thus, the strain sensors 80J can achieve correct detection. A rotation detecting portion 82J that detects the rotation of the crankshaft 30 is disposed on the control board 81J. The rotation detecting portion 82J internally includes, for example, a Hall element, and is disposed at a position overlapping a magnet 86J provided on the outer peripheral portion of the crankshaft 30. The Hall element detects the variation in the magnetic field of the magnet 86J by the rotation of the crankshaft 30, thus allowing measurement of the number of rotations of the crankshaft 30. Note that the configuration of the rotation detecting portion 82J is not limited to this.

### Eleventh Embodiment

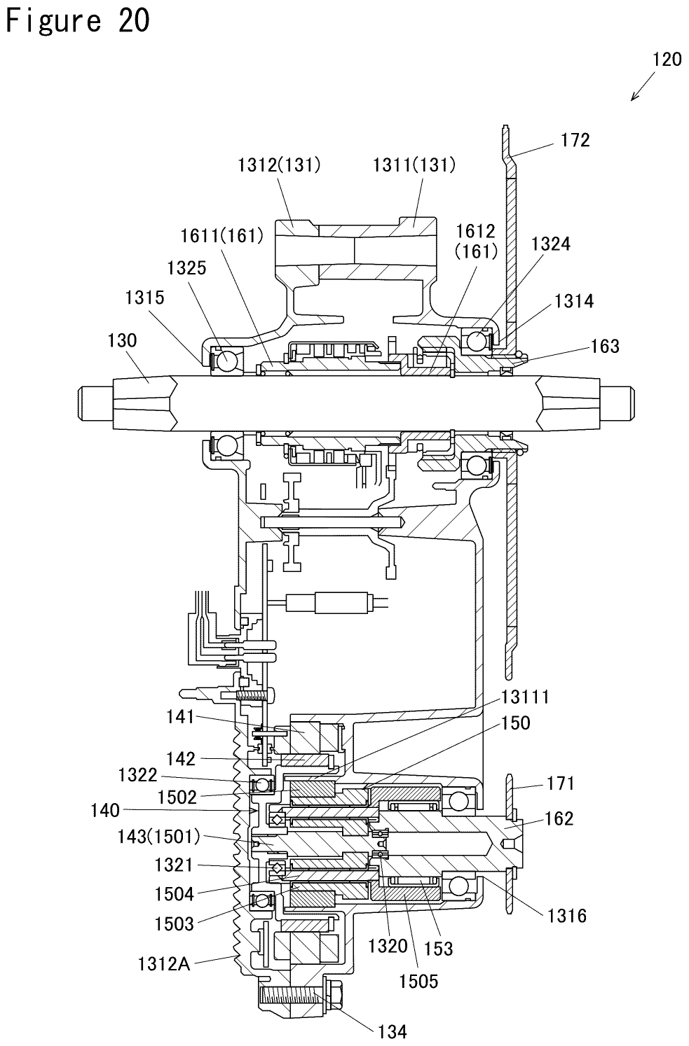

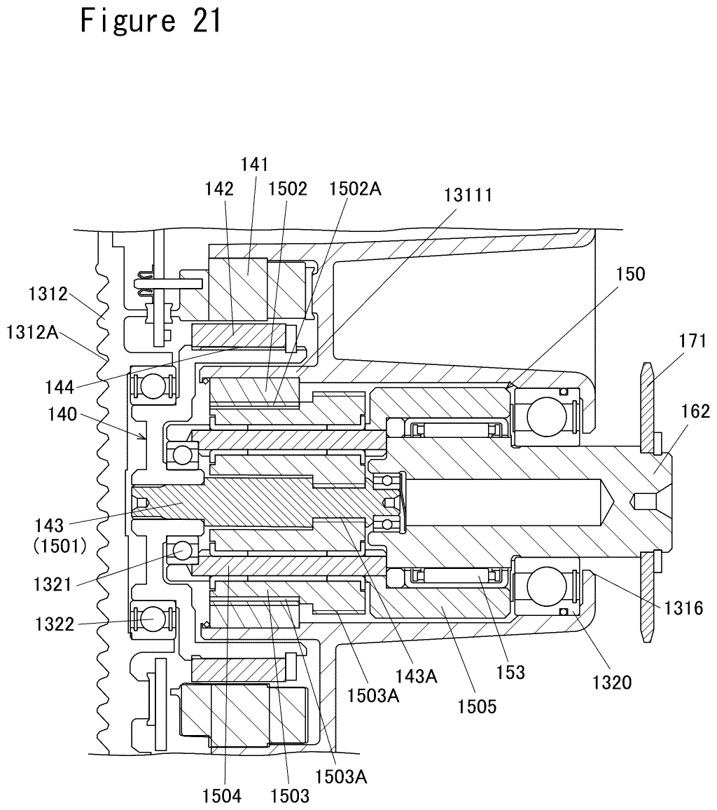

Next, by reference to FIGS. 20 and 21, an eleventh embodiment of a drive unit in the present disclosure is described. FIG. 20 is a sectional view of a drive unit 120 according to the eleventh embodiment. FIG. 21 shows an enlarged view of the vicinity of a motor 140 in FIG. 20. Hereinafter, components common to those in the first embodiment are assigned the same symbols, redundant description of these components is omitted, and the differences from the first embodiment are mainly described.

As shown in FIG. 20, the drive unit 120 includes: the motor 140 for applying rotational power for assisting the pedaling force on pedals 7; a housing 131 that houses the motor 140; and a crankshaft 130 rotatably attached to the housing 131.

The drive unit 120 includes: a human power transmission body 161 that is attached so as to rotate integrally with the crankshaft 130 and is rotated by a human-power driving force; a first output body 162 that outputs the rotational power of the motor 140; and a second output body 163 that outputs the rotational power by the human-power driving force. The drive unit 120 includes: a first sprocket 171 that outputs the rotational power of the first output body 162; a second sprocket 172 that outputs the rotational power of the second output body 163; and a planetary gear mechanism 150 as a power transmission mechanism that decelerates the rotational power of the motor 140 and transmits the power to the first sprocket 171 via the first output body 162. That is, the first sprocket 171 outputs the rotational power of the motor 140, and the second sprocket 172 outputs the rotational power of the human-power driving force.

The motor 140 includes a stator 141, a rotor 142, and a motor shaft 143 that rotates integrally with the rotor 142. In the present embodiment, the motor 140 is an inner-rotor type motor. Note that the motor 140 may be an outer-rotor type motor.

The rotor 142 has an annular shape that has a circular opening portion 144 (see FIG. 21) at the rotation center, and is disposed inside the stator 141. Inside the opening portion 144 in the radial direction there are a sun gear 1501, an internal gear 1502, planetary gears 1503, and planetary gear shafts 1504 that are gears constituting the planetary gear mechanism 150.

The rotor 142 and the motor shaft 143 are fixed to each other by serrations. Note that the rotor 142 and the motor shaft 143 may be fixed by press-fitting, shrink-fitting, cool-fitting, or the like. When the rotor 142 and the motor shaft 143 are fixed, an elastic member, such as any of a rubber member and urethane, may be provided between the rotor 142 and the motor shaft 143.

The motor shaft 143 is a cylindrical shaft-shaped member extending in the left-right direction, and rotates integrally with the rotor 142. The motor shaft 143 is disposed such that its rotation axis is along the axial direction of the crankshaft 130. The motor shaft 143 is rotatably supported by bearings 1320, 1321, and 1322 provided in the housing 131, so as to be rotatable with respect to the housing 131.

As shown in FIG. 21, the motor shaft 143 is disposed such that the central axis of rotation passes through the center of the internal gear 1502 included in the planetary gear mechanism 150 and penetrates through the internal gear 1502. Tooth portions 143A to mesh with tooth portions 1503A of the planetary gears 1503 included in the planetary gear mechanism 150 are provided on the surface of the motor shaft 143. The motor shaft 143 constitutes the sun gear 1501 of the planetary gear mechanism 150.

Note that the size, shape, and the like of the motor 40 in the first embodiment may be appropriately adopted as the size, shape, and the like of the motor 140.

The housing 131 is a member that constitutes an outer shell of the drive unit 120, and houses the motor 140. The housing 131 is formed mainly of metal, such as aluminum, stainless steel, or the like. Alternatively, non-metal may be used. No specific limitation is imposed on the material of the housing 131.

The housing 131 includes: a first divided body 1311 that constitutes the right half of the housing 131; and a second divided body 1312 that constitutes the left half of the housing 131. The first divided body 1311 and the second divided body 1312 are joined together with a fastener member 134, such as a bolt. By joining the first divided body 1311 and the second divided body 1312 to each other, the hollow housing 131 is formed. Note that no particular limitations are imposed on the size, shape, thickness and the like of the housing 131. The space formed in the housing 131 may be closed, or not closed.

The first divided body 1311 includes a protruding portion 13111 that protrudes to the left. The internal gear 1502 included in the planetary gear mechanism 150 is fitted to the protruding portion 13111.

A plurality of grooves 1312A are formed in the wall surface of the second divided body 1312. Thus, the area of a portion of the second divided body 1312 that is in contact with external air can be increased. As a result, the temperature of the housing 131 can be lowered, and the reliability of the drive unit 120 can be improved. Note that grooves may be formed in the wall surface of the first divided body 1311 instead of or in addition to the wall surface of the second divided body 1312.

The inside of the housing 131 houses the human power transmission body 161, part of the first output body 162, part of the second output body 163, and the planetary gear mechanism 150, in addition to the motor 140. The housing 131 is provided with through-holes 1314 and 1315 through which the crankshaft 130 penetrates. Furthermore, the housing 131 is provided with a through-hole 1316 through which the first output body 162 penetrates.

Note that in the present embodiment, the housing 131 is attached to the outer side of a frame 2, but may be housed in the frame 2 instead, similar to the housing 31 in the first embodiment. In the case of housing the housing 131 in the frame 2, a heat dissipation member that transfers heat of the housing 131 to the frame 2 may be disposed between the housing 131 and the frame 2.

The crankshaft 130 is a cylindrical member rotationally driven by the human-power driving force. The crankshaft 130 may be made up of a hollow member, or may be made up of a solid member.

A pair of crank arms (not shown) are provided at the opposite ends of the crankshaft 130. The opposite ends of the crankshaft 130 protrude outward from the housing 131. The crankshaft 130 is rotatably supported by bearings 1324 and 1325 at the housing 131 (frame 2). The bearings 1324 and 1325 are made up of, for example, ball bearings.

The planetary gear mechanism 150 is a mechanism that decelerates the rotational power of the motor 140, and transmits the power to the first sprocket 171 via the first output body 162. In the present embodiment, the planetary gear mechanism 150 includes: the motor shaft 143 as the sun gear 1501; the internal gear 1502 disposed on a concentric circle of the sun gear 1501; the planetary gears 1503 that mesh with the sun gear 1501 and the internal gear 1502; the planetary gear shafts 1504; and a planetary carrier 1505 as an output shaft.

The internal gear 1512 has an annular shape. Tooth portions 1502A are formed over the entire region of the inner peripheral surface. The internal gear 1502 is non-rotatably fixed to the housing 131 by being fitted to the protruding portion 13111 of the housing 131.

The planetary gear 1503 is a stepped planetary gear that includes two gears having different outer diameters. The tooth portions 1503A are formed over the entire periphery of each planetary gear 1503. The small-diameter portion of the planetary gear 1503 meshes with the internal gear 1502, and the large-diameter portion of the planetary gear 1503 meshes with the sun gear 1501. Use of the stepped planetary gear 1503 facilitates an increase in the reduction ratio of the planetary gear mechanism 150. Note that, similar to the first embodiment, the planetary gear 1503 is not necessarily the stepped planetary gear.

The planetary gear shafts 1504 penetrate through the centers of the respective planetary gears 1503, and hold these planetary gears 1503 in a freely rotatable manner. The planetary carrier 1505 supports the planetary gears 1503 to allow them to orbit. The rotation axis of the planetary carrier 1505 is positioned concentrically on the rotation axis of the sun gear 1501.

As shown in FIG. 21, the rotor 142, and the tooth portions 143A of the motor shaft 143, the tooth portions 1502A of the internal gear 1502, and the tooth portions 1503A of the planetary gears 1503 are disposed at overlapping positions in the axial direction of the crankshaft 130. Accordingly, in the axial direction of the crankshaft 130, the size of the drive unit 120 can be reduced.

At least parts of the tooth portions 143A of the motor shaft 143, the tooth portions 1502A of the internal gear 1502, and the tooth portions 1503A of the planetary gears 1503 are disposed inside the opening portion 144 of the rotor 142 in the radial direction. Accordingly, the drive unit 120 can be further reduced in size.

Note that the shapes, sizes, materials and the like of the gears of the planetary gear mechanism 51 in the first embodiment may be appropriately adopted as the shapes, sizes, materials and the like of the planetary gear mechanism 150.

The rotational power of the motor 140 output from the planetary gear mechanism 150 is transmitted to the first output body 162 via a one-way clutch 153. When the rotational power in the forward direction is applied to the planetary carrier 1505, the one-way clutch 153 transmits the rotational power to the first output body 162. When the rotational power in the direction opposite to the forward direction is applied to the planetary carrier 1505, the one-way clutch 153 does not transmit the rotational power to the first output body 162.

The human power transmission body 161 is a cylindrical member that extends along the axial direction of the crankshaft 130, and is disposed on the outer peripheral portion of the crankshaft 130 in the housing 131. The human power transmission body 161 rotates integrally with the crankshaft 130. In the present embodiment, the human power transmission body 161 is divided into a first human power transmission body 1611 and a second human power transmission body 1612. Note that the human power transmission body 161 may be made up of a single member.

The first human power transmission body 1611 is coupled to the crankshaft 130. Splines or serrations to be fitted to the crankshaft 130 are formed in the inner peripheral surface of the first human power transmission body 1611. Note that a tooth missing part may be provided at a site where the first human power transmission body 1611 and the crankshaft 130 are fitted to each other. This allows positioning in the assembling direction, and facilitates assembly. The first human power transmission body 1611 and the crankshaft 130 may be fitted together by press-fitting or with a screw.

The second human power transmission body 1612 is disposed on the right side of the first human power transmission body 1611 in the axial direction of the crankshaft 130. The second human power transmission body 1612 is coupled to the first human power transmission body 1611, and transmits the rotational power to the second output body 163.

In the present embodiment, splines or serrations to be fitted to the inner peripheral surface of the left end of the second human power transmission body 1612 are formed in the outer peripheral surface of the right end of the first human power transmission body 1611. Accordingly, the first human power transmission body 1611 and the second human power transmission body 1612 are coupled to each other.

The first output body 162 is a shaft-shaped member which extends along the axial direction of the crankshaft 130 and to which the rotational power of the motor 140 is transmitted. The rotation axis of the first output body 162 is concentrically positioned on the rotation axis of the motor shaft 143 (sun gear 1501). The rotational power of the motor 140 output from the planetary gear mechanism 150 is transmitted to the first output body 162 via the one-way clutch 153.

The length of the first output body 162 in the axial direction of the crankshaft 130 is shorter than the length of the crankshaft 130, and ranges, for example, from 10% to 50%, inclusive, of the length of the crankshaft 130 in the axial direction. The right end of the first output body 162 protrudes to the outside of the housing 131 through the through-hole 1316 provided in the housing 131. The first output body 162 is rotatably supported by a bearing 1326 at the housing 131.

Splines or serrations to be fitted to the first sprocket 171 are formed in a portion of the first output body 162 that protrudes to the outside of the housing 131. Accordingly, the first sprocket 171 rotates integrally with the first output body 162.

The second output body 163 is a cylindrical member that extends along the axial direction of the crankshaft 130, and is disposed on the outer peripheral portion of the crankshaft 130. The rotation axis of the second output body 163 is concentrically positioned on the rotation axis of the crankshaft 130.

Splines or serrations to be fitted to the outer peripheral portion of the second human power transmission body 1612 are formed in the inner peripheral surface on the left end side of the second output body 163. Accordingly, the second output body 163 rotates integrally with the second human power transmission body 1612. That is, the rotational power by the human-power driving force output from the human power transmission body 161 is transmitted to the second output body 163.

The length of the second output body 163 in the axial direction of the crankshaft 130 is shorter than the length of the crankshaft 130, and ranges, for example, from 10% to 50%, inclusive, of the length of the crankshaft 130 in the axial direction. The right end of the second output body 163 protrudes to the outside of the housing 131 through the through-hole 1314 provided in the housing 131. The second output body 163 is rotatably supported by the bearing 1324 at the housing 131.

Splines or serrations to be fitted to the second sprocket 172 are formed in a portion of the second output body 163 that protrudes to the outside of the housing 131. Accordingly, the second sprocket 172 rotates integrally with the second output body 163.

The first sprocket 171 is disposed on the rear side of the second sprocket 172. A chain (not shown) is wound around the first sprocket 171 and the second sprocket 172. The distance between the center of the first sprocket 171 and the center of the second sprocket 172 is, for example, equal to or less than 150 mm, and may be equal to or less than 135 mm.

The second sprocket 172 has a larger outer diameter than the first sprocket 171. The number of teeth of the second sprocket 172 is greater than the number of teeth of the first sprocket 171.

### Twelfth Embodiment

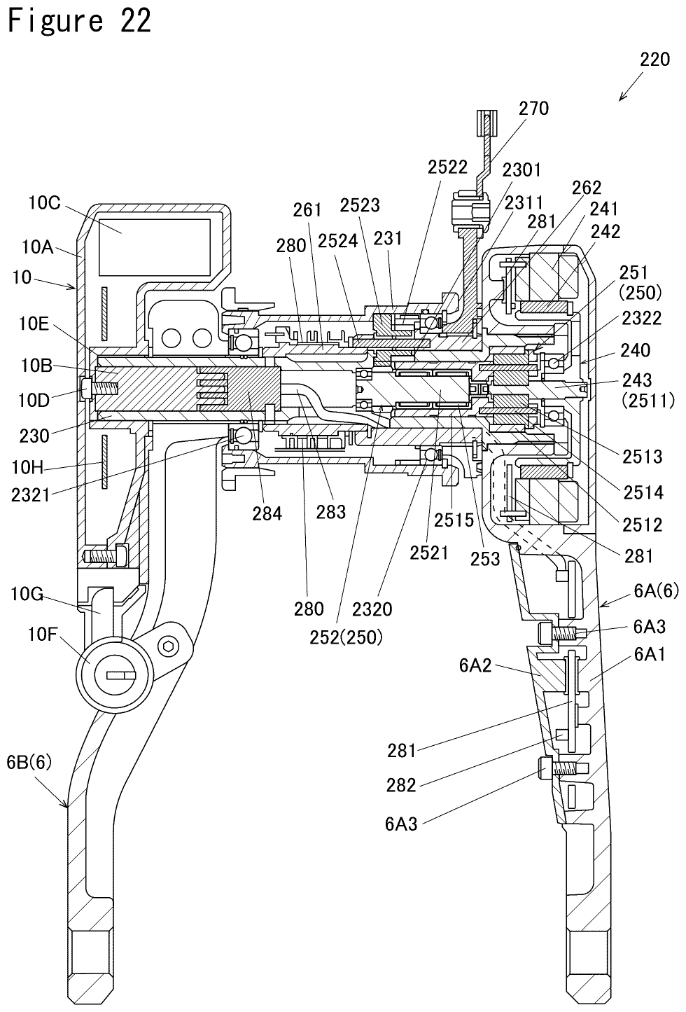

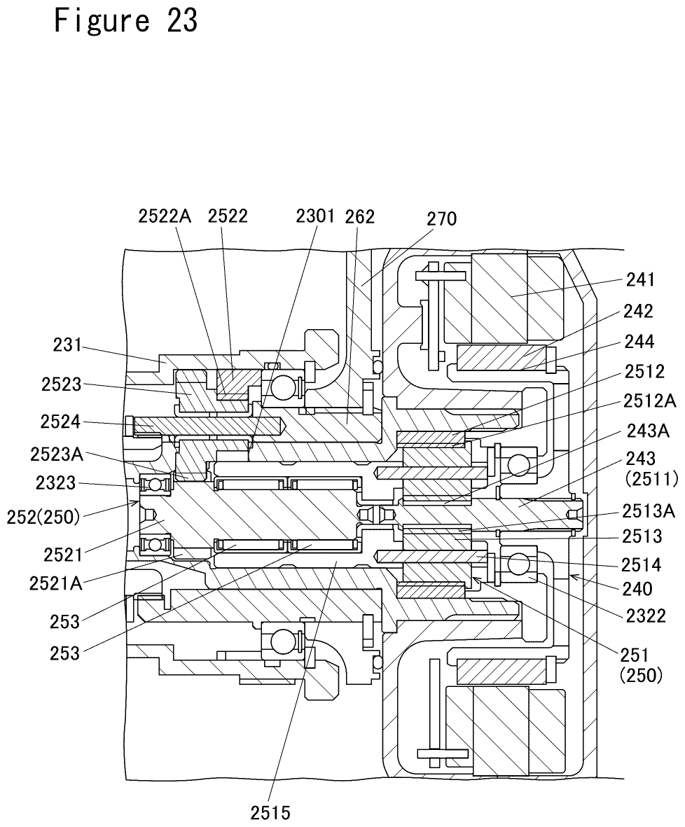

Next, by reference to FIGS. 22 and 23, a twelfth embodiment of a drive unit in the present disclosure is described. FIG. 22 is a sectional view of a drive unit 220 according to the twelfth embodiment. FIG. 23 shows an enlarged view of the vicinity of a motor 240 in FIG. 22. Hereinafter, components common to those in the first embodiment are assigned the same symbols, redundant description of these components is omitted, and the differences from the first embodiment are mainly described.

As shown in FIG. 22, the drive unit 220 includes: the motor 240 for applying rotational power for assisting the pedaling force on pedals 7; a housing 231 that constitutes part of an outer shell of the drive unit 220; and a crankshaft 230 rotatably attached to the housing 231. As described in detail later, the rotation axis of the motor 240 and the rotation axis of the crankshaft 230 are concentrically disposed.

The drive unit 220 further includes: a pair of crank arms 6 that have hollow structures; a human power transmission body 261 that is attached so as to rotate integrally with the crankshaft 230, and is rotated by a human-power driving force; an output body 262 that outputs the rotational power of the motor 240; a sprocket 270 that outputs the rotational power of the output body 262; and a power transmission mechanism 250 that decelerates the rotational power of the motor 240, and transmits the power to the sprocket 270 via the output body 262. As described in detail later, the power transmission mechanism 250 is made up of two stages of speed reduction mechanisms, and includes: a first planetary gear mechanism (first power transmission mechanism) 251 that is a first-stage speed reduction mechanism; and a second planetary gear mechanism (second power transmission mechanism) 252 that is a second-stage speed reduction mechanism.

The crankshaft 230 is a cylindrical member that has a hollow structure and opens at the opposite ends. At least part of the power transmission mechanism 250 is disposed in the crankshaft 230. Accordingly, the drive unit 220 can be further reduced in size. The crankshaft 230 is provided with a through-hole 2301 through which a planetary gear 2523, described later, penetrates. The crankshaft 230 is rotatably supported by bearings 2320 and 2321 at the housing 231 (frame 2). The bearings 2320 and 2321 are made up of, for example, ball bearings.

The opposite ends of the crankshaft 230 protrude outward from the housing 231. A right crank arm 6A is connected to the right end of the crankshaft 230. The right crank arm 6A includes: a base portion 6A1 that constitutes a main part of the right crank arm 6A and has an opening portion on the left side; and a lid portion 6A2 that blocks the opening portion. The base portion 6A1 and the lid portion 6A2 are joined to each other with a fastener member 6A3, such as a bolt. By joining the base portion 6A1 and the lid portion 6A2 together, the hollow right crank arm 6A is formed.

The internal space of the crankshaft 230 and the internal space of the right crank arm 6A communicate with each other. The left end side of the crankshaft 230 penetrates through the left crank arm 6B, and a power storage device 10 is attached to the left end of the crankshaft 230. Although described in detail later, the power storage device 10 has a configuration such that it is attachable to and detachable from the left end of the crankshaft 230.

Splines or serrations to be fitted to an internal gear 2512 included in the first planetary gear mechanism 251, described later, are formed in the inner peripheral surface of the crankshaft 230 on its right end side.

The housing 231 is a cylindrical member that extends along the axial direction of the crankshaft 230 and covers the center portion of the crankshaft 230. The housing 231 is fixed in, for example, a bottom bracket (not shown). Parts of the human power transmission body 261 and the output body 262 are housed in the housing.

Splines or serrations to be fitted to an internal gear 2522 included in the second planetary gear mechanism 252, described later, are formed in the inner peripheral surface of the housing 231 on its right end side.

As shown in FIG. 23, the motor 240 includes a stator 241, a rotor 242, and a motor shaft 243 that rotates integrally with the rotor 242. In the present embodiment, the motor 240 is an inner-rotor type motor. Note that the motor 240 may be an outer-rotor type or axial gap type motor.

The motor 240 is housed in the crank arm 6 (right crank arm 6A) and in the crankshaft 230. Specifically, the stator 241 and the rotor 242 are housed in the right crank arm 6A, and the motor shaft 243 is housed in the crankshaft 230. By housing the motor 240 in the crank arms 6 and in the crankshaft 230, the size of the drive unit 220 can be reduced.

The rotor 242 has an annular shape that has a circular opening portion 244 at the rotation center, and is disposed inside the stator 241. Inside the opening portion 244 in the radial direction there are parts of a sun gear 2511, the internal gear 2512, planetary gears 2513, and a planetary gear shaft 2514 that are gears constituting the first planetary gear mechanism 251.

The rotor 242 and the motor shaft 243 are fixed to each other by serrations. Note that the rotor 242 and the motor shaft 243 may be fixed by press-fitting, shrink-fitting, cool-fitting, or the like. When the rotor 242 and the motor shaft 243 are fixed, an elastic member, such as any of a rubber member and urethane, may be provided between the rotor 242 and the motor shaft 243.

The motor shaft 243 is a cylindrical shaft-shaped member extending in the left-right direction, and rotates integrally with the rotor 242. The motor shaft 243 is disposed such that its rotation axis is along the axial direction of the crankshaft 230. The motor shaft 243 is rotatably supported by a bearing 2322 provided in the right crank arm 6A with respect to the crankshaft 230 and the right crank arm 6A.

The motor shaft 243 is disposed such that the central axis of rotation passes through the center of the internal gear 2512 included in the planetary gear mechanism 251, and penetrates through the internal gear 2512. Tooth portions 243A to mesh with tooth portions 2513A of the planetary gears 2513 included in the first planetary gear mechanism 251 are provided on the surface of the motor shaft 243. That is, the motor shaft 243 functions as the sun gear 2511 of the first planetary gear mechanism 251, and constitutes a gear of the first planetary gear mechanism 251.

Note that the size, shape, and the like of the motor 40 in the first embodiment may be appropriately adopted as the size, shape, and the like of the motor 240.

The power transmission mechanism 250 is a mechanism that decelerates the rotational power of the motor 240, and transmits the power to the sprocket 270 via the output body 262. In the present embodiment, the power transmission mechanism 250 is made up of two stages of speed reduction mechanisms, and includes: the first planetary gear mechanism 251 that is a first-stage speed reduction mechanism; and the second planetary gear mechanism 252 that is a second-stage speed reduction mechanism. Note that the power transmission mechanism 250 may be made up of a single-stage speed reduction mechanism.

As shown in FIG. 23, the first planetary gear mechanism 251 includes: the motor shaft 243 as the sun gear 2511; the internal gear 2512 disposed on the concentric circle of the sun gear 2511; the planetary gears 2513 that mesh with the sun gear 2511 and the internal gear 2512; the planetary gear shafts 2514; and a planetary carrier 2515 as an output shaft.

The internal gear 2512 has an annular shape. Tooth portions 2512A are formed over the entire region of the inner peripheral surface. The internal gear 2512 is non-rotatably fixed to the crankshaft 230 by being fitted to the inner peripheral surface of the crankshaft 230.

The tooth portions 2513A are formed over the entire periphery of each planetary gear 2513. The planetary gear shafts 2514 penetrate through the centers of the respective planetary gears 2513, and hold these planetary gears 2513 in a freely rotatably manner. The planetary carrier 2515 supports the planetary gears 2513 to allow them to orbit. The rotation axis of the planetary carrier 2515 is positioned concentrically on the rotation axis of the sun gear 2511.

As shown in FIG. 23, the rotor 242, and the tooth portions 243A of the motor shaft 243, the tooth portions 2512A of the internal gear 2512, and the tooth portions 2513A of the planetary gears 2513 are disposed at overlapping positions in the axial direction of the crankshaft 230. Accordingly, in the axial direction of the crankshaft 230, the size of the drive unit 220 can be reduced.

At least parts of the tooth portions 243A of the motor shaft 243, the tooth portions 2512A of the internal gear 2512, and the tooth portions 2513A of the planetary gears 2513 are disposed inside the opening portion 244 of the rotor 242 in the radial direction. Accordingly, the drive unit 220 can be further reduced in size.

The rotational power of the motor 240 output from the first planetary gear mechanism 251 is transmitted to the second planetary gear mechanism 252 via a one-way clutch 253. When the rotational power in the forward direction is applied to the planetary carrier 2515, the one-way clutch 253 transmits the rotational power to the sun gear 2521 as an input shaft of the second planetary gear mechanism 252. When the rotational power in the direction opposite to the forward direction is applied to the planetary carrier 2515, the one-way clutch 253 does not transmit the rotational power to the sun gear 2521.

As shown in FIG. 23, the second planetary gear mechanism 252 includes: the sun gear 2521 as an input shaft; the internal gear 2522 disposed on the concentric circle of the sun gear 2521; the planetary gears 2523 that mesh with the sun gear 2521 and the internal gear 2522; and planetary gear shafts 2524.

As for the sun gear 2521, the rotation axis of the sun gear 2521 is concentrically positioned on the rotation axis of the crankshaft 230. As described above, the rotational power of the motor 240 output from the first planetary gear mechanism 251 is transmitted to the sun gear 2521 via the one-way clutch 253. The sun gear 2521 is rotatably supported by the bearing 2323 provided on the left end side with respect to the crankshaft 230.

The internal gear 2522 has an annular shape. Tooth portions 2522A are formed over the entire region of the inner peripheral surface. The internal gear 2522 is non-rotatably fixed to the housing 231 by being fitted to the inner peripheral surface of the housing 231.

The planetary gear 2523 is a stepped planetary gear that includes two gears having different outer diameters. The tooth portions 2523A are formed over the entire periphery of each planetary gear 2523. The small-diameter portion of the planetary gear 2523 meshes with the internal gear 2522, and the large-diameter portion of the planetary gear 2523 meshes with the sun gear 2521. Use of the stepped planetary gear 2523 facilitates an increase in the reduction ratio of the second planetary gear mechanism 252. Note that similar to the first embodiment, the planetary gear 2523 is not necessarily the stepped planetary gear.

The planetary gear shafts 2524 penetrate through the centers of the respective planetary gears 2523, and hold these planetary gears 2523 in a freely rotatable manner. The planetary gear shafts 2524 are inserted into through-holes formed in the output body 262, and are fitted thereinto. Accordingly, the rotational power of the motor 240 output from the second planetary gear mechanism 252 is transmitted to the output body 262.

Note that the shapes, sizes, materials, and the like of the gears of the planetary gear mechanism 51 in the first embodiment may be appropriately adopted as the shapes, sizes, materials, and the like of the gears of the first planetary gear mechanism 251 and the second planetary gear mechanism 252.

As shown in FIG. 22, the human power transmission body 261 is a cylindrical member that extends along the axial direction of the crankshaft 230, and is disposed on the outer peripheral portion of the crankshaft 230 in the housing 231. The human power transmission body 261 rotates integrally with the crankshaft 230. In the present embodiment, the human power transmission body 261 is made up of a single member. Similar to the first embodiment, it may be made up of multiple members.

The human power transmission body 261 is coupled to the crankshaft 230. Splines or serrations to be fitted to the crankshaft 230 are formed in the inner peripheral surface of the human power transmission body 261 on its left end side. The human power transmission body 261 and the crankshaft 230 may be fitted together by press-fitting or with a screw. The length of the human power transmission body 261 in the axial direction of the crankshaft 230 is shorter than the length of the crankshaft 230, and ranges, for example, from 10% to 50%, inclusive, of the length of the crankshaft 230 in the axial direction. Note that the drive unit 220 does not necessarily include the human power transmission body 261. In this case, the output body 262 and the crankshaft 230 are engaged together with splines or the like, and the rotational power of the crankshaft 230 is transmitted to the output body 262. In the case without the human power transmission body 261, the strain of the crankshaft 230 may be detected by a strain sensor pasted to the outer peripheral surface of the crankshaft 230, and the input human power torque may thus be detected. The input human power torque may be detected by detecting the load on the outer wheel side of a bearing 2321 through the strain sensor. This negates the need for the human power transmission body 261, and further facilitates reduction in the size and weight of the drive unit 220.

Tooth portions to mesh with tooth portions provided on the inner peripheral surface of the output body 262 are provided on the outer peripheral portion on the right end side of the human power transmission body 261. Accordingly, the rotational power by the human-power driving force is transmitted to the output body 262 via the human power transmission body 261. Note that a one-way clutch may be provided between the human power transmission body 261 and the output body 262.

The output body 262 is a cylindrical member that extends along the axial direction of the crankshaft 230, and is disposed on the outer peripheral portion of the crankshaft 230. The rotation axis of the output body 262 is concentrically positioned on the rotation axis of the crankshaft 230.

The length of the output body 262 in the axial direction of the crankshaft 230 is shorter than the length of the crankshaft 230, and ranges, for example, from 10% to 50%, inclusive, of the length of the crankshaft 230 in the axial direction. The output body 262 is rotatably supported by the bearing 2320 at the housing 231.

The right end of the output body 262 protrudes to the outside of the housing 231 through a through-hole 2311 provided in the housing 231. Splines or serrations to be fitted to the sprocket 270 are formed in a portion of the output body 262 that protrudes to the outside of the housing 231. Accordingly, the sprocket 270 rotates integrally with the output body 262.

Note that the human power transmission body 261 and the output body 262 are separately provided in the present embodiment, but may be integrally configured. For example, the human power transmission body 261 is not necessarily provided, and it may be the case that only the output body 262 is provided. In this case, by transmitting the rotational power of the crankshaft 230 by the human-power driving force to the output body 262, the power-assisted bicycle 1 is allowed to travel forward.

A one-way clutch may be disposed between the output body 262 and the sprocket 270. When the rotational power in the forward direction is applied to the output body 262, the one-way clutch transmits the rotational power to the sprocket 270. When the rotational power in the direction opposite to the forward direction is applied to the output body 262, the one-way clutch does not transmit the rotational power to the sprocket 270.

As shown in FIG. 22, the drive unit 220 includes torque detecting portions 280 that detect the torque of the human-power driving force; and a control board 281 on which a control device (not shown) for controlling the output of the motor 240 in response to the detected torque and achieving an appropriate power assisting function is disposed. The drive unit 220 further includes a rotation detecting portion 282 for detecting the rotation of the crankshaft 230.

The torque detecting portions 280 are provided on the outer peripheral portion of the human power transmission body 261, and detect the strain applied to the human power transmission body 261. For example, a strain sensor that detects a physical strain may be used as each torque detecting portion 280. For example, a scheme may be used according to which a paint that emits light in response to a mechanical stimulus is applied to the outer peripheral portion of the human power transmission body 261 and the light is detected by an optical sensor.

In the case of detecting the torque using the strain sensor, the drive unit 220 includes a total of two torque detecting portions 280, one at each of the opposite positions in the circumferential direction on the outer peripheral portion of the human power transmission body 261. Note that the number of torque detecting portions 280 provided on the outer peripheral portion of the human power transmission body 261 may be only one, or three or more. The installation positions of the torque detecting portions 280 are not limited to the outer peripheral portion of the human power transmission body 261, and may be, for example, on the outer peripheral portion of the crankshaft 230.

The control device is disposed on the control board 281, and controls the rotation of the motor 240 based on the torque detected by each torque detecting portion 280. The control device controls the rotation of the motor 240 based on detection information on the rotation detecting portion 282. A conventionally publicly known configuration may be adopted as the configuration of the control device. The torque detecting portions 280 may communicate with the control device using signal lines or wireless signals. Note that the control board 281 on which the control device is disposed may be disposed adjacent to the motor 240 as shown in FIG. 22. For example, a rotor rotation detecting portion for detecting the rotation of the rotor 242 may be provided on the control board 281 disposed adjacent to the motor 240.

In the present embodiment, the control board 281 is housed in the right crank arm 6A. That is, the control board 281 rotates integrally with the crankshaft 230. The control board 281 is housed in the right crank arm 6A, which can facilitate reduction in size of the drive unit 220.

The rotation detecting portion 282 detects the number of rotations of the crankshaft 230. The rotation detecting portion 282 is, for example, an inertial sensor, such as an acceleration sensor or a gyroscope sensor. Note that the configuration of the rotation detecting portion 282 is not limited to this.

In the present embodiment, at least part of the rotation detecting portion 282 is disposed on the control board 281. That is, at least part of the rotation detecting portion 282 rotates integrally with the crankshaft 230. Accordingly, reduction in size of the drive unit 220 can be facilitated. Note that at least part of the rotation detecting portion 282 may be disposed on the crankshaft 230 or the human power transmission body 261.

The rotation detecting portion 282 may communicate with the control device using signal lines and preferably using wireless signals. This can omit the space that houses a signal line connecting the rotation detecting portion 282 and the control device to each other, and facilitates reduction in the size of the drive unit 220.

As shown in FIG. 22, the power storage device 10 is attached to the left end of the crankshaft 230. That is, the power storage device 10 rotates integrally with the crankshaft 230.

The power storage device 10 includes: a housing body 10A that houses a storage battery 10C and is disposed outside the crankshaft 230; and a connector 10B connected to the housing body 10A. The housing body 10A and the connector 10B are joined to each other with a fastener member 10D, such as a bolt. The housing body 10A includes a depressed portion 10E into which the crankshaft 230 is fitted. A control board 10H that controls the power storage device 10 is provided in the housing body 10A.

The power storage device 10 has a configuration such that it is attachable to and detachable from the crankshaft 230. Specifically, a lock mechanism 10F is provided on the outside of the housing body 10A in the radial direction of the rotation axis of the crankshaft 230. When the lock mechanism 10F is unlocked, a protruding portion 10G is retracted from an engagement site, and the fastening at the depressed portion 10E is loosened, and the power storage device 10 can be removed from the crankshaft 230. By locking the lock mechanism 10F in a state in which the crankshaft 230 is fitted into the depressed portion 10E, the protruding portion 10G is fitted to the engagement site, the crankshaft 230 is fastened by the depressed portion 10E, and the power storage device 10 is fixed to the crankshaft 230. Note that no specific limitation is imposed on the configuration of the lock mechanism 10F so long as the configuration allows the power storage device 10 to be attached to and detached from the crankshaft 230. For example, the lock mechanism 10F may be disposed in the axial direction of the crankshaft 230.

The connector 10B is disposed in the crankshaft 230, and is configured to be insertable into the left end of an internal connector 284 in the crankshaft 230. It is configured such that the outer diameter of the connector 10B is smaller than the inner diameter of the crankshaft 230. A cable 283 that supplies electric power to the components constituting the drive unit 220, such as the motor 240, is connected to the right end of the internal connector 284. In the example in FIG. 22, the cable 283 passes through the crankshaft 230, and is connected to the control board 281 disposed in the right crank arm 6A.

Note that the method of supplying electric power to the components constituting the drive unit 220 is not limited to this. For example, the power storage device 10 may be attached to the frame 2, and the electric power may be supplied to the drive unit 220 using a slip ring. For example, the drive unit 220 includes: an electric power receiving portion that rotates integrally with the crankshaft 230; and an electric power supplying portion that is fixed to the frame 2 and includes a brush for supplying electric power to the electric power supplying portion. The electric power receiving portion is provided with the slip ring. The distal end portion of the brush is in contact and slid by rotation of the slip ring, and electric power is supplied from the brush to the slip ring. Note that the method of supplying electric power using the slip ring is not limited to the form described above.

Note that the design of each of the embodiments described above may be appropriately changed in a range without changing the advantage of the present disclosure. For example, in each of the embodiments, the power-assisted bicycle 1 provided with the crank arms 6 at the opposite ends of the crankshaft 30, 130, 230 is described. Alternatively, this may apply to an electric vehicle without the crank arms 6 at the opposite ends of the crankshaft 30, 130, 230. That is, the vehicle may be an electric vehicle that does not travel forward by a human-power driving force, but travels forward by the rotational power of the motor.

### REFERENCE SIGNS LIST

1 Power-assisted bicycle; 2 Frame; 2A Head tube; 2B Front forks; 2C Top tube; 2D Bottom tube; 2E Seat tube; 2F Seat stays; 2G Chain stays; 3A Front wheel; 3B Rear wheel; 4 Handlebars; 5 Saddle; 6 Crank arm; 6A Right crank arm; 6A1 Base portion; 6A2 Lid portion; 6A3 Fastener member; 6B Left crank arm; 7 Pedals; 8 Chain; 10 Power storage device; 10A Housing body; 10B Connector; 10C Storage battery; 10D Fastener member; 10E Depressed portion; 10F Lock mechanism; 10G Protruding portion; 10H Control board; 11 Rear wheel sprocket; 20, 20A, 20B, 20C, 20D, 20E, 20F, 20G, 120, 220 Drive unit; 30, 130, 230 Crankshaft; 31, 31E, 31F, 131, 231 Housing; 33 Heat dissipation member; 34, 134, 341, 342 Fastener member; 35 Heat dissipation member; 36 Protrusion member; 40, 40A, 40D, 140, 240 Motor; 41, 41A, 41D, 141, 241 Stator; 42, 42A, 42D, 142, 242 Rotor; 43, 43D, 143, 243 Motor shaft; 43A, 143A, 243A, 512A, 513A, 541A, 542A, 1502A, 1503A, 2512A, 2513A, 2522A, 2523A Tooth portions; 44, 144, 244 Opening portion; 50, 50B, 50C, 50F, 50G, 250 Power transmission mechanism; 51, 51B, 51F, 150, 251 Planetary gear mechanism; 52 Second speed reduction mechanism; 53, 53G, 63, 153, 253 One-way clutch; 61, 161, 162 Human power transmission body; 62, 262 Output body; 70, 270 Sprocket; 80, 280 Torque detecting portion; 81, 281 Control board; 82, 282 Rotation detecting portion; 83, 283 Cable; 84 Connector; 85 Rotor rotation detecting portion; 86, 86J Magnet; 162 First output body; 163 Second output body; 171 First sprocket; 172 Second sprocket; 251 First planetary gear mechanism; 252 Second planetary gear mechanism; 284 Internal connector; 311, 311E, 311F, 1311 First divided body; 312, 312E, 312F, 1312 Second divided body; 313E, 313F Third divided body; 314, 315, 1314, 1315, 1316, 2301, 2311 Through-hole; 320, 321, 322, 323, 324, 325, 326, 327, 1329, 1321, 1322, 1324, 1325, 1326, 2320, 2321, 2322, 2323 Bearing; 511, 511F, 1501, 2511, 2521 Sun gear; 512, 512F, 1502, 2512, 2522 Internal gear; 513, 513F, 1503, 2513, 2523 Planetary gear; 514, 514F, 1504, 2514, 2524 Planetary gear shaft; 515, 515B, 515C, 515F, 1505, 2515 Planetary carrier; 516 Output member; 521, 541 First transmission gear; 522, 543 Second transmission gear; 542 Gear shaft; 611, 1611 First human power transmission body; 612, 1612 Second human power transmission body; 841 First portion; 842 Second portion; 1312A Grooves; 3111, 3131, 13111 Protruding portion; 3112, 3132 Depressed portion; 5121 Annular portion; 5122 Connection portion; 5123 Cylindrical body portion; 5151 Hollow portion; 5161 Protruding portion; 5162 Small-diameter portion

1. A drive unit for use in an electric vehicle, comprising:
a motor that includes a rotor having an opening portion at a rotation center;
a housing that houses the motor;
a crankshaft rotatably attached to the housing;
a sprocket that outputs a rotational power of the motor; and
a power transmission mechanism that decelerates or accelerates the rotational power of the motor to transmit the power to the sprocket,
wherein the power transmission mechanism includes at least one gear provided with tooth portions on a surface,
the rotor and the tooth portions are disposed at positions overlapping in an axial direction of the crankshaft, and
at least part of the gear is disposed inside the opening portion.

2. A drive unit for use in an electric vehicle, comprising:
a motor that includes a rotor having an opening portion at a rotation center;
a housing that houses the motor;
a crankshaft that is rotatably attached to the housing, and is rotatable by a human-power driving force;
a first sprocket that outputs a rotational power of the motor;
a second sprocket that outputs a rotational power of the human-power driving force; and
a power transmission mechanism that decelerates or accelerates the rotational power of the motor to transmit the power to the first sprocket,
wherein the power transmission mechanism includes at least one gear provided with tooth portions on a surface,
the rotor and the tooth portions are disposed at positions overlapping in an axial direction of the crankshaft, and
at least part of the gear is disposed inside the opening portion.

3. The drive unit according to claim 1,
wherein the crankshaft is rotatable by a human-power driving force, and the drive unit further comprises:
a torque detecting portion that detects the human-power driving force applied to the crankshaft; and
a control device that controls rotation of the motor, based on detection information on the torque detecting portion.

4. The drive unit according to claim 1, wherein the power transmission mechanism includes a planetary gear mechanism that includes planetary gears, planetary gear shafts, and a planetary carrier.

5. The drive unit according to claim 4, wherein the gears of the planetary gear mechanism include a helical gear.

6. The drive unit according to claim 4, wherein the planetary gear mechanism further includes an internal gear, and the internal gear is non-rotatably fixed to the housing.

7. The drive unit according to claim 4, wherein the planetary gear mechanism further includes a sun gear, and the sun gear is non-rotatably fixed to the housing.

8. The drive unit according to claim 4, wherein the planetary carrier is non-rotatably fixed to the housing.

9. The drive unit according to claim 1,
wherein the power transmission mechanism is a mechanism that decelerates or accelerates the rotational power of the motor in multiple stages, and includes:
a first power transmission mechanism; and
a second power transmission mechanism which is on a subsequent-stage side of the first power transmission mechanism on a transmission path and to which a rotational power of the first power transmission mechanism is transmitted, the power transmission mechanism further includes:
a first bearing that rotatably supports gears included in the second power transmission mechanism, at the housing; and
a one-way clutch provided between the first power transmission mechanism and the second power transmission mechanism, and
the first bearing and the one-way clutch are disposed at positions overlapping in the axial direction of the crankshaft.

10. The drive unit according to claim 1,
wherein the power transmission mechanism decelerates or accelerates the rotational power of the motor in multiple stages,
the power transmission mechanism includes:
a first power transmission mechanism that includes a sun gear, planetary gears, a planetary carrier, and an internal gear; and
a second power transmission mechanism which is on a subsequent-stage side of the first power transmission mechanism on a transmission path and to which a rotational power of the first power transmission mechanism is transmitted,
a second bearing that rotatably supports the sun gear at the housing is provided at one end of the sun gear in the housing,
the second bearing and the second power transmission mechanism are disposed at positions overlapping in the axial direction of the crankshaft, and
a rotation axis of the rotor and a rotation axis of the crankshaft are respectively disposed on different axes.

11. The drive unit according to claim 5,
wherein the power transmission mechanism includes a cylindrical output member that meshes with an output shaft of the planetary gear mechanism,
the output member includes a small-diameter portion formed to have a smaller diameter than other portions, and
a third bearing that rotatably supports the output member at the housing is disposed on an outer side of the small-diameter portion in a radial direction.

12. The drive unit according to claim 1, wherein the power transmission mechanism includes a parallel shaft gear mechanism having a gear that meshes with a motor shaft as an output shaft of the motor and has a rotation axis disposed in parallel with a rotation axis of the motor shaft.

13. The drive unit according to claim 1, further comprising a control board on which a control device that controls rotation of the motor is disposed,
wherein the control board is joined to the motor.

14. The drive unit according to claim 1,
wherein the motor includes a stator, and
the stator has an outer diameter equal to or smaller than 100 mm.

15. The drive unit according to claim 1,
wherein the motor includes a stator, and
the stator has an outer diameter equal to or smaller than 90 mm.

16. The drive unit according to claim 1, wherein the rotor has an inner diameter equal to or greater than 30 mm.

17. The drive unit according to claim 1, wherein the rotor has an inner diameter equal to or greater than 40 mm.

18. The drive unit according to claim 3, further comprising a rotation detecting portion that detects rotation of the crankshaft,
wherein at least part of the rotation detecting portion is disposed on a board on which the control device is disposed.

19. The drive unit according to claim 18, wherein the torque detecting portion is disposed on the board.

20. The drive unit according to claim 3,
wherein a cable extending from an outside of the drive unit is connected via a connector to the board on which the control device is disposed, and
the connector includes a first portion that extends in a substantially normal direction of a surface of the board, and a second portion that extends in a direction inclined from the substantially normal direction of the surface of the board.

21. The drive unit according to claim 3,
wherein the torque detecting portion rotates integrally with the crankshaft, and
the torque detecting portion and the control device communicate with each other by a wireless signal.

22. The drive unit according to claim 1,
wherein the housing is fixed to a frame of the electric vehicle, and
the housing includes a heat dissipating portion that transfers heat to the frame.

23. The drive unit according to claim 1,
wherein an interior of the housing is partitioned into at least two spaces, and
a space which is one of the spaces and in which the power transmission mechanism is disposed houses lubrication oil.

24. A drive unit for use in an electric vehicle, comprising:
a motor that includes a rotor having an opening portion at a rotation center;
a housing;
a crankshaft rotatably attached to the housing;
a sprocket that outputs a rotational power of the motor; and
a power transmission mechanism that decelerates or accelerates the rotational power of the motor to transmit the power to the sprocket,
wherein the power transmission mechanism includes at least one gear provided with tooth portions on a surface,
the rotor and the tooth portions are disposed at positions overlapping in an axial direction of the crankshaft, and
a rotation axis of the rotor and a rotation axis of the crankshaft are concentrically disposed.

25. The drive unit according to claim 24,
wherein the crankshaft has a hollow structure, and
at least part of the power transmission mechanism is housed in the crankshaft.

26. The drive unit according to claim 24, further comprising a power storage device that supplies electric power to the motor,
wherein the power storage device rotates integrally with the crankshaft.

27. The drive unit according to claim 24, further comprising a one-way clutch disposed between the crankshaft and the power transmission mechanism,
wherein the one-way clutch receives a radial load.

28. The drive unit according to claim 27, wherein the one-way clutch is disposed closer to the sprocket in the axial direction of the crankshaft than an axial-direction center portion of the crankshaft.

29. A drive unit for use in an electric vehicle, comprising:
a motor;
a housing that houses the motor;
a crankshaft rotatably attached to the housing;
a sprocket that outputs a rotational power of the motor; and
a power transmission mechanism that decelerates or accelerates the rotational power of the motor to transmit the power to the sprocket; and
a rotation detecting portion that detects rotation of the crankshaft or of a member rotating integrally with the crankshaft, and
wherein the rotation detecting portion rotates integrally with the crankshaft.

30. The drive unit according to claim 29, further comprising a control device that controls a rotation of the motor, based on detection information on the rotation detecting portion,
wherein the rotation detecting portion and the control device communicate with each other by a wireless signal.

31. The drive unit according to claim 30, wherein the rotation detecting portion and the control device are disposed on the same board.

32. A drive unit for use in an electric vehicle, comprising:
a motor;
a housing that houses the motor;
a crankshaft rotatably attached to the housing;
a sprocket that outputs a rotational power of the motor; and
a power transmission mechanism that decelerates or accelerates the rotational power of the motor to transmit the power to the sprocket,
wherein the motor includes:
a motor shaft that is an output shaft;
a stator fixed to the housing; and
a rotor that is fixed to the motor shaft and includes a magnet,
the rotor is disposed so as to face the stator in a direction along a rotation axis of the motor shaft,
the power transmission mechanism includes at least one gear provided with tooth portions on a surface, and
the stator and the tooth portions are disposed at positions overlapping in an axial direction of the crankshaft.

33. The drive unit according to claim 32, wherein the rotor is disposed only on one side of the stator in the direction along the rotation axis of the motor shaft.

34. The drive unit according to claim 32, further comprising a plurality of bearings that rotatably support the motor shaft at the housing,
wherein the plurality of bearings are separately disposed in the direction along the rotation axis of the motor shaft.

35. The drive unit according to claim 1, further comprising a bearing that rotatably supports the crankshaft, and a torque detecting portion detects a load applied to the bearing.

36. An electric vehicle, comprising the drive unit according to claim 1.
